(19) United States
(12) Patent Application Publication
(10) Pub. No.: US 2026/0192333 A1
(43) Pub. Date: Jul. 9, 2026

(54) VIBRATING DEVICE

(71) Applicant: Murata Manufacturing Co., Ltd., Nagaokakyo-shi (JP)

(72) Inventors: Akihiro HIRAKA, Nagaokakyo-shi (JP); Noritaka KISHI, Nagaokakyo-shi (JP); Yuuki ISHII, Nagaokakyo-shi (JP); Hitoshi SAKAGUCHI, Nagaokakyo-shi (JP)

(21) Appl. No.: 19/553,991

(22) Filed: Mar. 2, 2026

Related U.S. Application Data
(63) Continuation of application No. PCT/JP2024/013703, filed on Apr. 3, 2024.

(30) Foreign Application Priority Data
Sep. 6, 2023 (JP) 2023-144368

(51) Int. Cl. B06B 1/06; G02B 27/00

(52) U.S. Cl. CPC B06B 1/0651; G02B 27/0006

(57) ABSTRACT

A vibrating device including: a tubular internal vibrator extending in a first direction; a piezoelectric element connected to a first end portion of the internal vibrator in the first direction; a light-transparent body connected to a second end portion of the internal vibrator in the first direction and having an optical axis extending in the first direction; and a tubular external vibrator surrounding the internal vibrator and extending in the first direction, wherein the external vibrator includes: a first connector connected to the light-transparent body, a cylinder portion connected to the first connector and extending in the first direction, and an attenuator extending from the cylinder portion in a direction away from the light-transparent body in a second direction intersecting with the first direction, and wherein at least one of the attenuator or the cylinder portion has nonaxisymmetry with respect to the optical axis.

### CROSS REFERENCE TO RELATED APPLICATIONS

The present application is a continuation of International application No. PCT/JP2024/013703, filed April 3, 2024, which claims priority to Japanese Patent Application No. 2023-144368, filed September 6, 2023, the entire contents of each of which are incorporated herein by reference.

### TECHNICAL FIELD

The present disclosure relates to a vibrating device.

### BACKGROUND ART

Patent Document 1 describes a vibrating device including nonequilibrium means for partially reducing mass from or adding mass to at least one of a light-transparent body, a first tubular body, a second tubular body, a spring, or a vibrator.

Patent Document 1: Japanese Patent No. 6819846

### SUMMARY OF THE DISCLOSURE

The vibrating device in Patent Document 1 has room for improvement in removal of foreign matter adhering to a light-transparent body.

The present disclosure aims to provide a vibrating device capable of removing foreign matter adhering to a light-transparent body.

A vibrating device according to an aspect of the present disclosure includes: a substantially tubular internal vibrator extending in a first direction; a piezoelectric element connected to a first end portion of the substantially tubular internal vibrator in the first direction; a light-transparent body connected to a second end portion of the substantially tubular internal vibrator in the first direction and having an optical axis extending in the first direction; and a substantially tubular external vibrator surrounding the substantially tubular internal vibrator and extending in the first direction, wherein the substantially tubular external vibrator includes: a first connector connected to the light-transparent body, a cylinder portion connected to the first connector and extending in the first direction, and an attenuator extending from the cylinder portion in a direction away from the light-transparent body in a second direction intersecting with the first direction, wherein the cylinder portion is spaced from the substantially tubular internal vibrator in the second direction, and wherein at least one of the attenuator or the cylinder portion has nonaxisymmetry with respect to the optical axis.

The present disclosure can provide a vibrating device capable of removing foreign matter adhering to a light-transparent body.

### BRIEF DESCRIPTION OF THE DRAWINGS

FIG. 1 is a schematic perspective view of a vibrating device according to an embodiment of the present disclosure.

FIG. 2 is a schematic cross-sectional view taken along line II-II in FIG. 1.

FIG. 3 is a schematic perspective view of the vibrating device in FIG. 1, viewed from below.

FIG. 4 is a schematic perspective view of an external vibrator in the vibrating device in FIG. 1.

FIG. 5 is a schematic cross-sectional view taken along line V-V in FIG. 4.

FIG. 6A is a schematic cross-sectional view of the external vibrator in the vibrating device in FIG. 1, excluding a fixed portion.

FIG. 6B is a schematic bottom view of the external vibrator illustrated in FIG. 6A, excluding a fixed portion.

FIG. 6C is a schematic cross-sectional view taken along line VIC-VIC in FIG. 6A.

FIG. 7 is a schematic cross-sectional perspective view of an arrangement example of a vibrating device.

FIG. 8 is a graph of an example of an amount of displacement of a lens surface of the vibrating device in FIG. 1.

FIG. 9A is a schematic cross-sectional view of an example of natural vibration of an internal vibrator in the vibrating device in FIG. 1.

FIG. 9B is a schematic cross-sectional view of an example of natural vibration (mode A) of an external vibrator in the vibrating device in FIG. 1.

FIG. 9C is a schematic cross-sectional view of an example of natural vibration (mode B) of the external vibrator in the vibrating device in FIG. 1.

FIG. 10A is a schematic cross-sectional view of another example of the external vibrator excluding the fixed portion.

FIG. 10B is a schematic bottom view of the external vibrator excluding the fixed portion in FIG. 10A.

FIG. 11 is a schematic cross-sectional view of a vibrating device according to a first modification example.

FIG. 12A is a schematic cross-sectional view of an external vibrator in the vibrating device in FIG. 11, excluding a fixed portion.

FIG. 12B is a cross-sectional view taken along line XIIB-XIIB in FIG. 12A.

FIG. 13 is a schematic perspective view of an arrangement example of the vibrating device in FIG. 11.

FIG. 14 is a graph of an example of an amount of displacement of the lens surface of the vibrating device in FIG. 11.

FIG. 15 is a schematic cross-sectional view of a vibrating device according to a second modification example.

FIG. 16 is a graph of an example of the amount of displacement of the lens surface of the vibrating device in FIG. 15.

FIG. 17 is a schematic perspective view of a vibrating device according to a third modification example.

FIG. 18 is a schematic cross-sectional view taken along line XVIII-XVIII in FIG. 17.

### DESCRIPTION OF THE PREFERRED EMBODIMENTS

Embodiments of the present disclosure are described below with reference to the drawings. The present disclosure is not limited to these embodiments. Throughout the drawings, components substantially the same are denoted with the same reference signs. For the purpose of illustration, the dimensions of each component may be exaggerated in the drawings, and are not necessarily in accordance with the scale.

Hereafter, for ease of description, terms indicating directions such as "up", "down", "right", "left", and "side", are used on the assumption of the normal usage, but they are used not to limit, for example, the usage of a vibrating device according to the present disclosure.

In the drawings described below, for reference, an X axis and a Z axis that are perpendicular to each other are schematically illustrated. In the following description, a simple description of a X direction or a Z direction indicates the corresponding axis direction, and includes two opposite directions (for example, a -X direction and a +X direction).

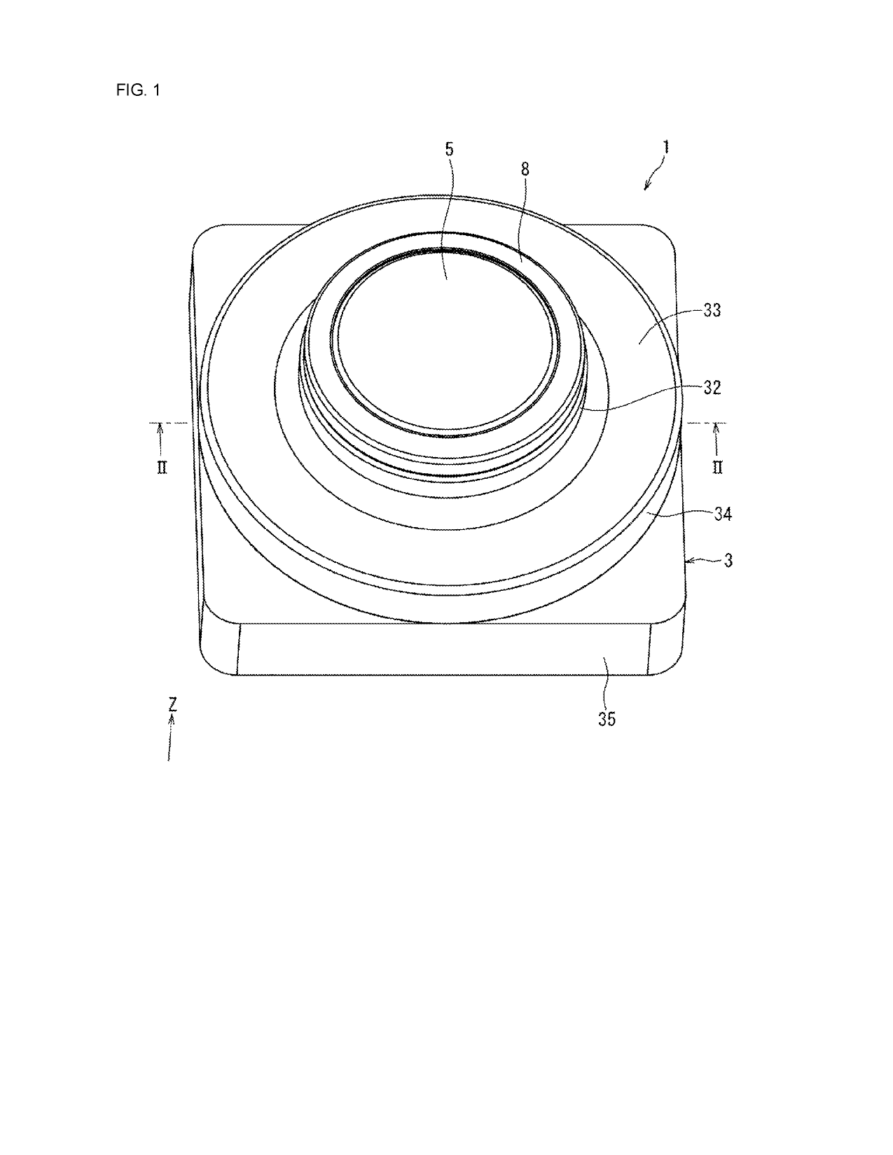

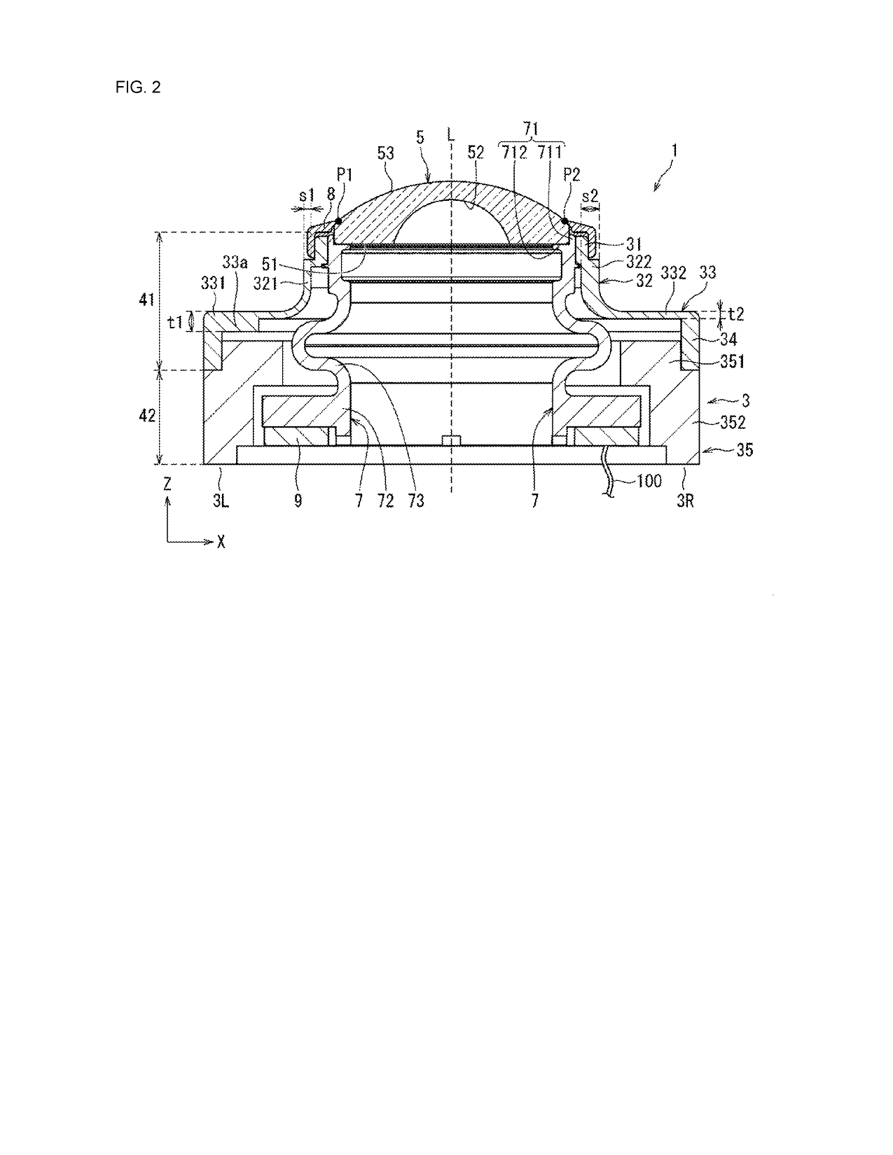

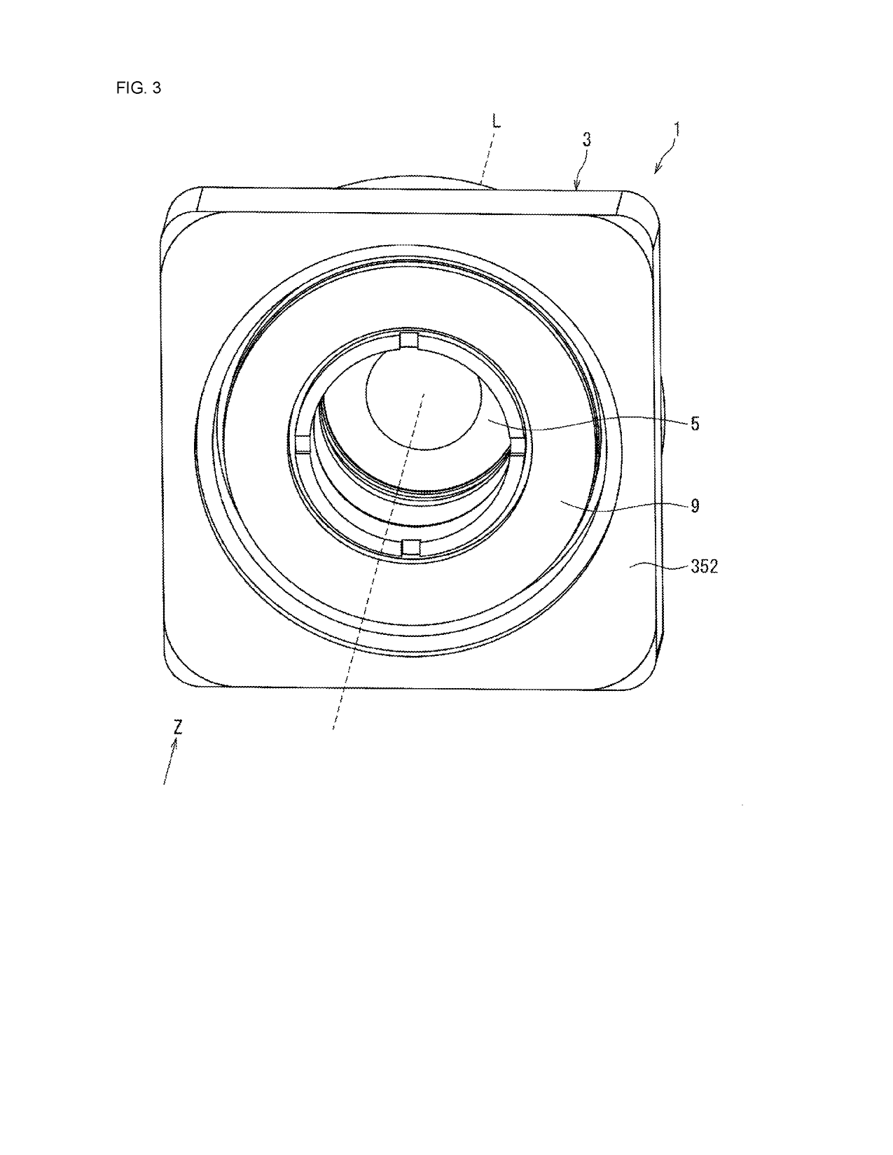

FIG. 1 is a perspective view of a vibrating device according to an embodiment of the present disclosure. FIG. 2 is a cross-sectional view taken along line II-II in FIG. 1. FIG. 3 is a perspective view of the vibrating device in FIG. 1, viewed from below. In these drawings, a direction parallel to an optical axis L of a light-transparent body in a vibrating device is defined as a Z direction (or a first direction), and a radial direction of an imaginary circle, centered on the optical axis L, on the plane perpendicular to the Z direction is defined as a X direction (or a second direction).

As illustrated in FIG. 1 to FIG. 3, a vibrating device 1 includes an internal vibrator 7, a piezoelectric element 9, a lens (an example of a light-transparent body) 5, and an external vibrator 3.

### Internal Vibrator 7

As illustrated in FIG. 2, the internal vibrator 7 is a substantially tubular body extending in the first direction Z. The piezoelectric element 9 is connected to a first end portion (a lower end portion in FIG. 2) of the internal vibrator 7 in the first direction Z. The lens 5 is connected to a second end portion (an upper end portion in FIG. 2) of the internal vibrator 7 in the first direction Z. The lens 5 has an optical axis L extending in the first direction Z. Vibrations generated by the piezoelectric element 9 are transmitted to the lens 5 through the internal vibrator 7, and the lens 5 vibrates. Foreign matter such as waterdrops or mud adhering to the lens 5 is thus removed.

The internal vibrator 7 is capable of amplifying vibrations generated by the piezoelectric element 9. The internal vibrator 7 is formed from, for example, a metal material or ceramics. Examples of a metal material forming the internal vibrator 7 include stainless steel, aluminum, iron, titanium, and duralumin. The surface of the internal vibrator 7 may be treated with, for example, oxidation or anodizing to improve adhesion of an adhesive. For example, when the surface of the internal vibrator 7 is blackened by surface treatment, reduction in optical characteristics caused by irregular reflection of light can be reduced.

In the present embodiment, the internal vibrator 7 has, for example, a substantially tubular shape extending in the first direction Z, and positioned symmetrically with respect to the optical axis L. The internal vibrator 7 includes an upper portion 71 that is in contact with the lens 5, a lower portion 72 to which the piezoelectric element 9 is attached, and an intermediate portion 73 that connects the upper portion 71 and the lower portion 72.

The upper portion 71 includes a cylindrical plate portion 711, and a protrusion 712 protruding in a second direction X intersecting with the first direction Z from the plate portion 711 toward the optical axis L. The protrusion 712 has, for example, an annular shape when viewed in a plan in the first direction Z. An edge portion (a lower edge portion) of the lens 5 is supported by the inner surface of the plate portion 711 and the upper surface of the protrusion 712. More specifically, at the lower edge portion of the lens 5, the lower surface of the lens 5 is in contact with the upper surface of the protrusion 712, and the side surface of the lens 5 is in contact with the inner surface (an inner circumference) of the plate portion 711. The lower portion 72 vibrates together with vibrations of the piezoelectric element 9, and is thicker than the upper portion 71 and the intermediate portion 73. This structure more efficiently transmits vibrations of the piezoelectric element 9 to the lens 5. The intermediate portion 73 has a substantially S-shaped cross-sectional shape. The intermediate portion 73 supports the upper portion 71, and transmits vibrations of the lower portion 72 to the upper portion 71.

The upper portion 71, the lower portion 72, and the intermediate portion 73 may be integrated together or formed separately. The maximum dimension (hereafter referred to as "maximum profile dimension".) of the intermediate portion 73 in the second direction X is greater than the maximum profile dimension of the upper portion 71, and the maximum profile dimension of the lower portion 72 is greater than the maximum profile dimension of the intermediate portion 73. This structure can thus efficiently transmit vibrations of the piezoelectric element 9 to the lens 5.

### External Vibrator 3

The external vibrator 3 reduces leakage of vibrations of the internal vibrator 7 to components other than the lens 5 to efficiently transmit vibrations to the lens 5. For example, the external vibrator 3 covers the entirety of the internal vibrator 7 to protect the internal vibrator 7 from the outside. The external vibrator 3 is formed from, for example, a metal material such as stainless steel, aluminum, iron, titanium, or duralumin, or resin.

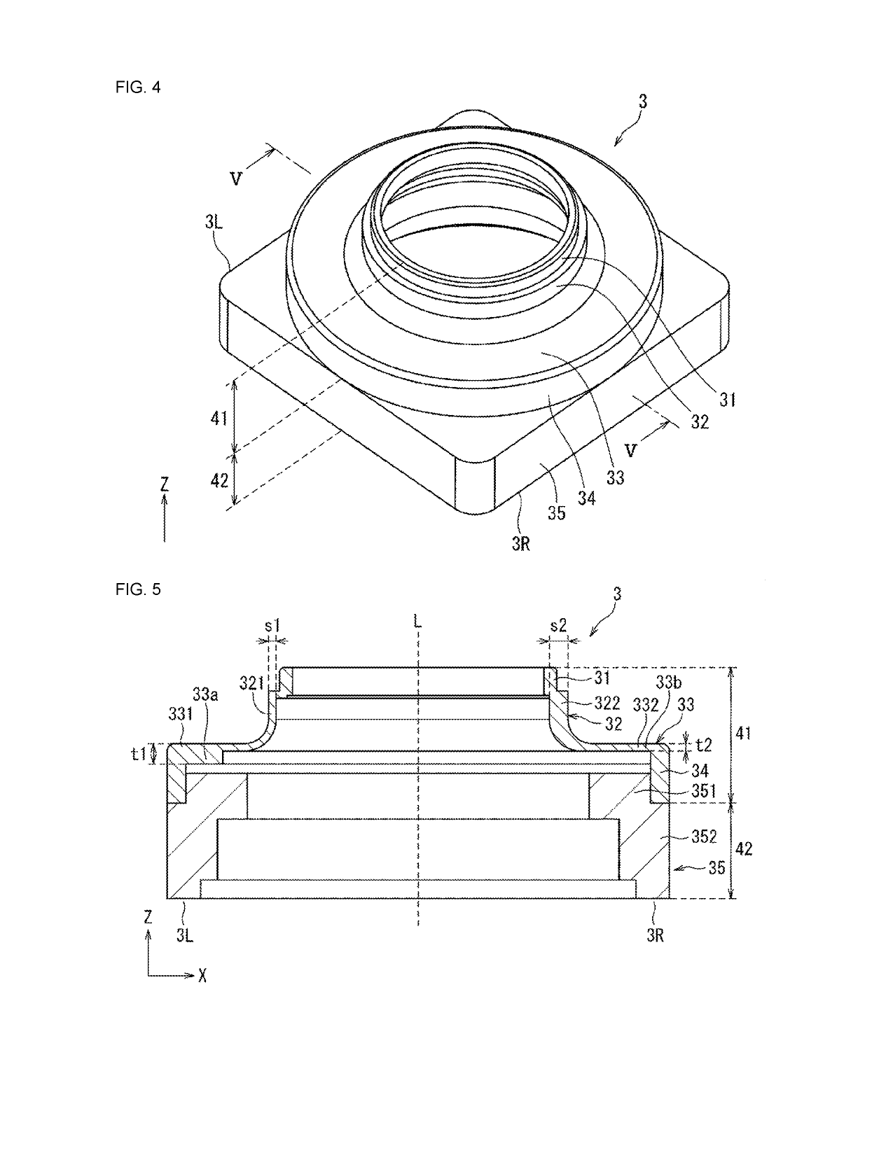

FIG. 4 is a schematic perspective view of an external vibrator in the vibrating device in FIG. 1. FIG. 5 is a schematic cross-sectional view taken along line V-V in FIG. 4.

As illustrated in FIG. 1 to FIG. 5, the external vibrator 3 is a substantially tubular body extending in the first direction Z. The external vibrator 3 has a through-hole extending throughout in the first direction Z and having a circular cross section. The external vibrator 3 is disposed to surround the internal vibrator 7. More specifically, the internal vibrator 7 is positioned inside the through-hole in the external vibrator 3.

As illustrated in FIG. 2 and FIG. 4, the external vibrator 3 includes a substantially cylindrical upper tubular body 41, and a substantially prism-shaped (here, substantially quadrangular-prism-shaped) lower tubular body 42. The upper tubular body 41 is positioned above the lower tubular body 42 (positioned closer to the lens 5). The maximum profile dimension of the upper tubular body 41 is smaller than the maximum profile dimension of the lower tubular body 42.

In the present embodiment, the external vibrator 3 includes a first connector 31, a cylinder portion 32, an attenuator 33, a second connector 34, and a fixed portion 35. The first connector 31, the cylinder portion 32, the attenuator 33, the second connector 34, and an upper portion 351 in the fixed portion 35 have a cylindrical shape, and form the upper tubular body 41. A lower portion 352 in the fixed portion 35 forms the lower tubular body 42.

The first connector 31 is connected to the lens 5. In the present embodiment, the first connector 31 is positioned at the upper end of the external vibrator 3, and has a cylindrical shape extending in the first direction Z. As illustrated in FIG. 2, the inner surface (inner circumferential surface) of the first connector 31 is in contact with the outer surface (outer circumferential surface) of the internal vibrator 7. The first connector 31 is connected to the lens 5 with the internal vibrator 7 interposed therebetween. The first connector 31 may be fixed to the lens 5 in any method, regardless of with the internal vibrator 7 or without the internal vibrator 7 interposed therebetween (for example, simply using an adhesive).

In the example illustrated in FIG. 2, the outer surface of the first connector 31 is covered with a cover member 8. The cover member 8 covers the outer surface and the upper surface of the first connector 31, the upper end portion (the upper surface of the plate portion 711) of the internal vibrator 7, and the edge portion of an upper surface 53 of the lens 5. The cover member 8 is, for example, a resin member or a metal member. When the cover member 8 is disposed to connect the first connector 31 and the lens 5, the first connector 31 and the lens 5 are more securely connected, and water or foreign matter on the lens 5 is less likely to enter the inside of the external vibrator 3.

The cylinder portion 32 is positioned below the first connector 31 (closer to the piezoelectric element 9). The cylinder portion 32 is positioned between the first connector 31 and the attenuator 33 in the first direction Z to connect the first connector 31 and the attenuator 33. The cylinder portion 32 has a cylindrical shape extending in the first direction Z. As illustrated in FIG. 2, in the cross section taken along the optical axis L, the cylinder portion 32 is disposed to surround the outer periphery of the internal vibrator 7 at a distance from the internal vibrator 7 in the second direction (radial direction) X. The inner diameter of the cylinder portion 32 is greater than the inner diameter of the first connector 31. Thus, a step is formed on the inner surface of the external vibrator 3, and a gap is formed between the cylinder portion 32 and the outer surface of the internal vibrator 7. The cylinder portion 32 has a smaller thickness than the fixed portion 35, and thus has spring characteristics. The cylinder portion 32 may have an oblique portion at which the diameter gradually increases toward the attenuator 33.

The attenuator 33 extends toward the outside of the lens 5 in the second direction X from the lower end portion of the cylinder portion 32. The attenuator 33 attenuates vibrations generated by the piezoelectric element 9. The attenuator 33 has a smaller thickness than the fixed portion 35, and thus has spring characteristics. The attenuator 33 is disposed to surround the outer periphery of the internal vibrator 7 at a distance from the internal vibrator 7 in the second direction X. The upper surface of the attenuator 33 has, for example, an annular shape, and is positioned symmetrically with respect to the optical axis L.

In the present embodiment, the attenuator 33 and the cylinder portion 32 in the external vibrator 3 have nonaxisymmetry with respect to the optical axis L. This structure can vary the amplitude of the lens 5 connected to the first connector 31 in the external vibrator 3 under vibration. A specific nonaxisymmetric structure is described later. Herein, "varying the amplitude of the lens 5" refers to forming, in the upper surface 53 of the lens 5, an area where the lens 5 vibrates with large amplitude and an area where the lens 5 vibrates with small amplitude.

The second connector 34 connects the attenuator 33 and the fixed portion 35. The second connector 34 has a cylindrical shape extending downward (in the -Z direction in this case) from the edge portion of the attenuator 33. The second connector 34 is integrated with, for example, the attenuator 33. The second connector 34 allows the attenuator 33 and the fixed portion 35 to be disposed at a distance from each other in the first direction Z.

The fixed portion 35 is positioned closer to the piezoelectric element 9 than the attenuator 33, and connected to the attenuator 33 with the second connector 34 interposed therebetween. The fixed portion 35 can reduce vibrations transmitted to a member connected to the fixed portion 35 (such as a case that accommodates an image pickup device, and a lens module). The fixed portion 35 has a greater thickness (thickness in the second direction X) than other portions of the external vibrator 3.

The fixed portion 35 includes, as described above, the cylindrical upper portion 351 and the quadrangular-prism-shaped lower portion 352. In the examples illustrated in FIG. 2 and FIG. 4, the second connector 34 is connected to the outer circumferential surface of the upper portion 351 in the fixed portion 35. More specifically, the inner side surface of the lower end portion in the second connector 34 is in contact with the outer surface of the upper portion 351 in the fixed portion 35 (for example, with an adhesive), and the lower surface of the second connector 34 is in contact with the upper surface of the lower portion 352 in the fixed portion 35.

The fixed portion 35 with a greater volume can reduce more vibrations of the fixed portion 35. However, simply enlarging the fixed portion 35 is less achievable while achieving size reduction of the vibrating device 1. The lower portion 352 in the fixed portion 35 according to the present embodiment has a profile with a substantially quadrangular prism shape. This structure can increase the volume of the fixed portion 35 without increasing the size of the vibrating device 1. For example, a 25 mm × 25 mm cube has a greater volume than a cylinder with a diameter of 25 mm. The external vibrator 3 is formed from a material with a lower Young's modulus than the internal vibrator 7. This structure allows the attenuator 33 to attenuate more vibrations.

In the external vibrator 3, the maximum width (maximum profile dimension) of the first connector 31 in the second direction (radial direction) X is smaller than the maximum profile dimension of the cylinder portion 32. The maximum profile dimension of the cylinder portion 32 is smaller than the maximum profile dimension of the attenuator 33. The maximum profile dimensions of the attenuator 33 and the second connector 34 are substantially the same, and smaller than the maximum profile dimension of the fixed portion 35. This structure allows a portion of the external vibrator 3 positioned closer to the lens 5 to more easily vibrate, and reduces vibrations of the lower portion 352 in the fixed portion 35.

In the present embodiment, simply the first connector 31 at the upper end of the external vibrator 3 is connected to the internal vibrator 7 or the lens 5. Portions of the external vibrator 3 positioned below the first connector 31 (here, the cylinder portion 32, the attenuator 33, the second connector 34, and the fixed portion 35) are not in contact with the internal vibrator 7. This structure can more efficiently impart a variation in the amplitude of the lens 5 without greatly losing axial symmetry of vibrations of the internal vibrator 7 (vibrations in the first direction Z).

The first connector 31, the cylinder portion 32, the attenuator 33, the second connector 34, and the fixed portion 35 may be integrated or formed individually. As illustrated, the first connector 31, the cylinder portion 32, the attenuator 33, and the second connector 34 may be integrated, separately from the fixed portion 35. When at least the cylinder portion 32 and the attenuator 33 are integrated, nonaxisymmetry can more efficiently be imparted to vibrations of the lens 5.

### Lens 5

For example, the lens 5 is formed from glass. As illustrated in FIG. 2, the upper surface 53 of the lens 5 has a convex shape, and is coated with, for example, water-repellent coating and antireflection coating (AR coating). The surface of the lens 5 (lower surface) facing the optical image-forming surface includes a flat portion 51 and a recessed portion 52. The edge portion of the upper surface 53 of the lens 5 is connected to the cover member 8 with, for example, an adhesive. The flat portion 51 is connected to the upper portion 71 in the internal vibrator 7 with, for example, an adhesive.

### Piezoelectric Element 9

The piezoelectric element 9 includes a piezoelectric body and an electrode, and is capable of generating vibrations. The piezoelectric body is formed from, for example, appropriate piezoelectric ceramics such as barium titanate (BaTiO₃), lead zirconate titanate (PZT: PbTiO₃-PbZrO₃), lead titanate (PbTiO₃), lead metaniobate (PbNb₂O₆), bismuth titanate (Bi₄Ti₃O₁₂), or (K,Na)NbO₃, or an appropriate piezoelectric monocrystal such as LiTaO₃, or LiNbO₃. The electrode is formed from, for example, Ni, Ag, or Au.

As illustrated in FIG. 2, the piezoelectric element 9 is positioned symmetrically with respect to the optical axis L. When viewed in a plan in the first direction Z, the piezoelectric element 9 has, for example, an annular shape. The piezoelectric element 9 is connected to the lower portion 72 in the internal vibrator 7 with, for example, an adhesive.

An adhesive is disposed between the lens 5 and the internal vibrator 7, between the piezoelectric element 9 and the internal vibrator 7, between the cover member 8 and the lens 5, and between the internal vibrator 7 and the external vibrator 3. The adhesive is formed from, for example, epoxy resin. Using an adhesive with a high Young's modulus can reduce a transmission loss of vibrations between two members.

### Nonaxisymmetric Structure of External Vibrator

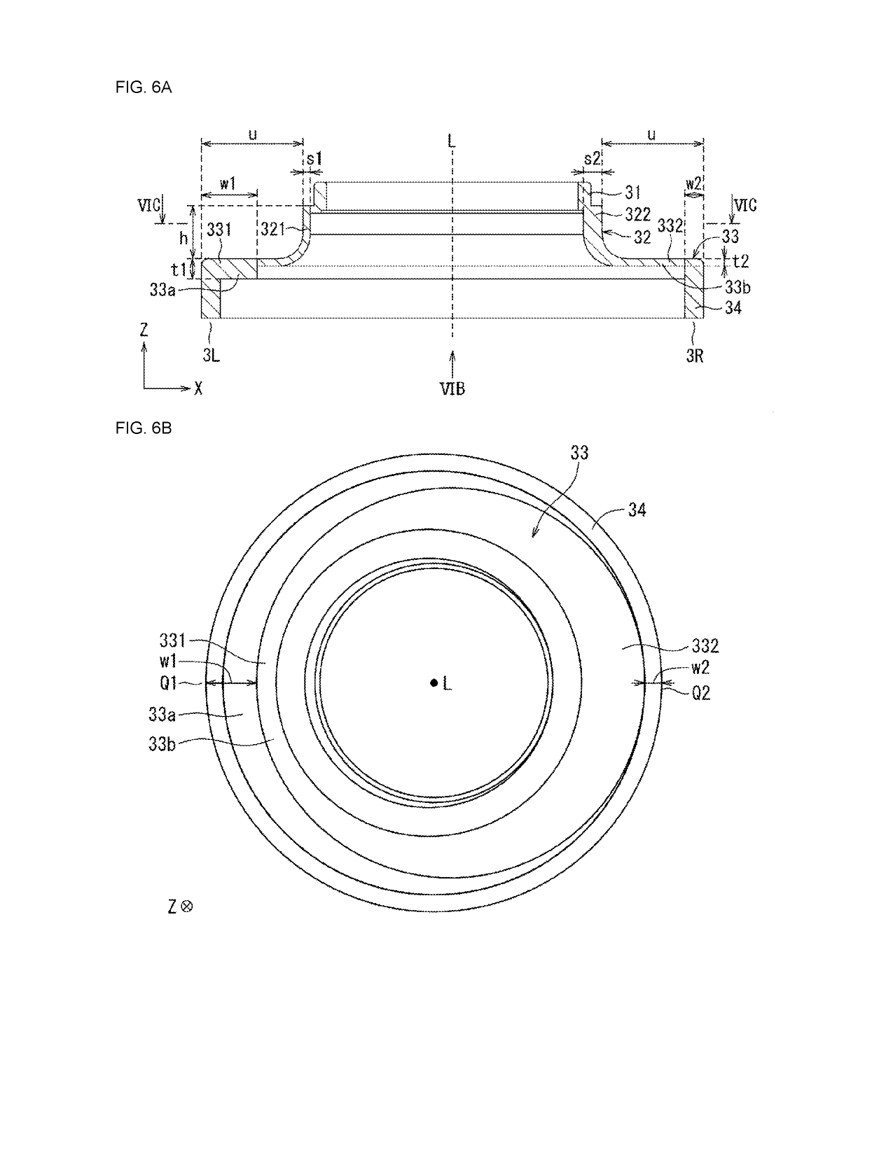

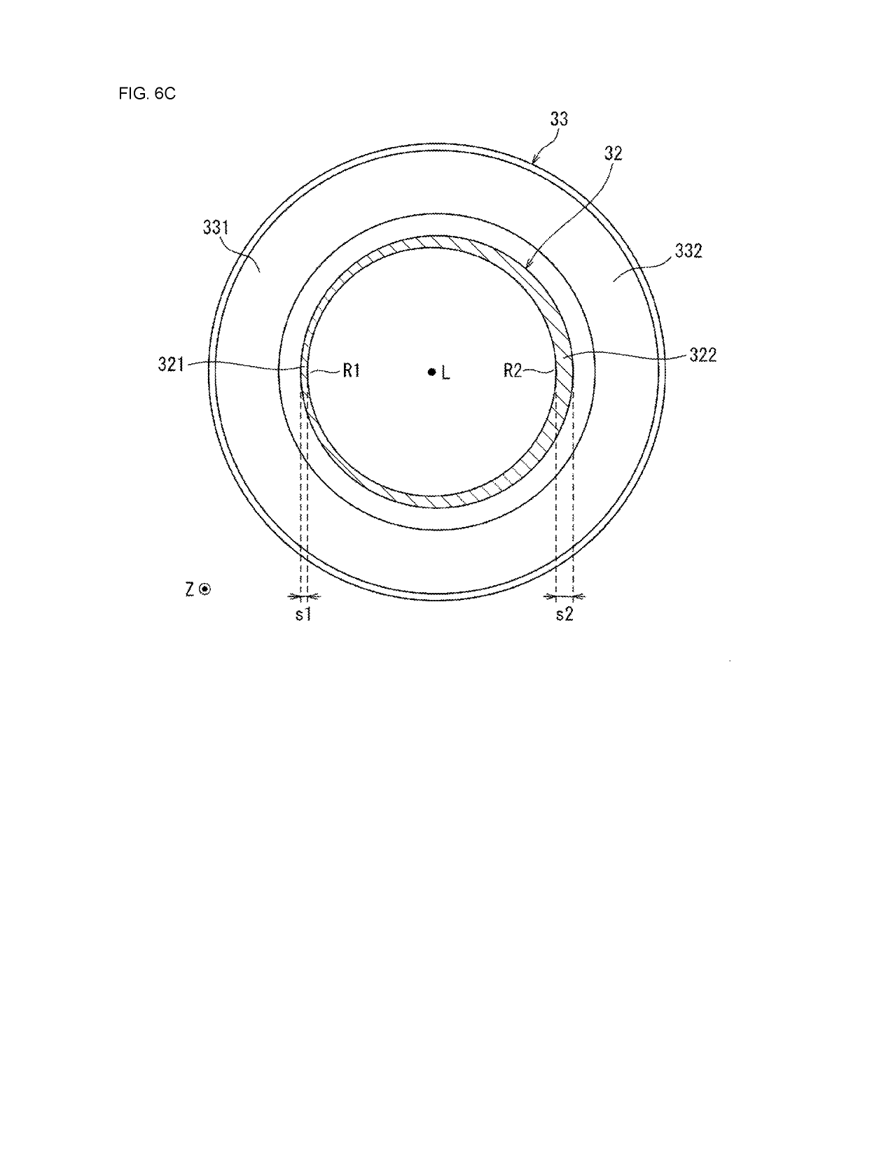

Hereafter, with reference to FIG. 2, and FIG. 4 to FIG. 6C, a nonaxisymmetric structure of an external vibrator is described in detail. FIG. 6A is a schematic cross-sectional view of the external vibrator in the vibrating device, excluding a fixed portion. FIG. 6B is a bottom view of the external vibrator illustrated in FIG. 6A, viewed from below. FIG. 6C is a schematic cross-sectional view taken along line VIC-VIC in FIG. 6A.

As illustrated in FIG. 6A, the attenuator 33 includes a first attenuator 331 and a second attenuator 332 positioned symmetrically with respect to the optical axis L in the cross section taken along the optical axis L. A thickness t1 of the first attenuator 331 in the first direction Z and a thickness t2 of the second attenuator 332 in the first direction Z differ from each other.

In the present embodiment, the thickness t1 of the first attenuator 331 is greater than the thickness t2 of the second attenuator 332. For example, the surface (upper surface) of the first attenuator 331 closer to the lens 5 in the first direction Z and the upper surface of the second attenuator 332 are substantially flush with each other (here, in the same plane perpendicular to the first direction Z). In contrast, the surface (lower surface) of the first attenuator 331 facing the piezoelectric element 9 in the first direction Z is positioned closer to the piezoelectric element 9 than (in the -Z direction from) the lower surface of the second attenuator 332.

The attenuator 33 includes a thick portion 33a, and a thin portion 33b with the thickness t2. The thick portion 33a is thicker than the thin portion 33b. The thick portion 33a includes a portion with the thickness t1, and a connection portion positioned outward from the portion with the thickness t2 and connected to the second connector 34. The width (w1 at a first portion Q1) of the thick portion 33a in the first attenuator 331 in the second direction X is greater than the width (w2 at the second portion Q2) of the thick portion 33a in the second attenuator 332. The width w2 of the thick portion 33a in the second portion Q2 is, for example, substantially the same as the thickness of the second connector 34 in the second direction X. In the example in FIG. 6B, the thick portion 33a extends in the circumferential direction. The width of the thick portion 33a in the second direction X gradually decreases in the circumferential direction from the first portion Q1 to the second portion Q2 to be maximum at the first portion Q1 in the first attenuator 331, and to be minimum at the second portion Q2 in the second attenuator 332 opposing the first portion Q1.

As illustrated in FIG. 6A, the cylinder portion 32 includes a first cylinder portion 321 and a second cylinder portion 322 positioned symmetric with respect to the optical axis L in the cross section taken along the optical axis L. The first cylinder portion 321 is positioned on the same side of the optical axis L as the first attenuator 331, and the second cylinder portion 322 is positioned on the same side of the optical axis L as the second attenuator 332. In the cross section taken along the optical axis L, a thickness s1 of the first cylinder portion 321 in the second direction X and a thickness s2 of the second cylinder portion 322 in the second direction X are different from each other.

In the present embodiment, the thickness s1 of the first cylinder portion 321 is smaller than the thickness s2 of the second cylinder portion 322. In the example in FIG. 6C, the thickness of the cylinder portion 32 in the second direction X gradually increases in the circumferential direction from the first portion R1 to the second portion R2 to be minimum at the first portion R1 in the first cylinder portion 321, and to be maximum at the second portion R2 in the second cylinder portion 322 opposing the first portion R1.

For example, the first portion R1 in the cylinder portion 32 is adjacent to the first portion Q1 in the attenuator 33 (positioned in the same direction when viewed from the optical axis L), and the second portion R2 in the cylinder portion 32 is adjacent to the second portion Q2 in the attenuator 33. This structure further facilitates amplitude adjustment with a combination in nonaxisymmetry of the cylinder portion 32 and the attenuator 33.

As illustrated in FIG. 2 and FIG. 5, in the cross section taken along the optical axis L, the external vibrator 3 includes a first external vibrator 3L positioned on a first side (-X side, or left side in FIG. 2) of the optical axis L and a second external vibrator 3R positioned on a second side (+X side, or right side in FIG. 2) of the optical axis L. The first external vibrator 3L includes the first attenuator 331 and the first cylinder portion 321. The second external vibrator 3R includes the second attenuator 332 and the second cylinder portion 322.

In the present embodiment, the external vibrator 3 is formed to allow nonaxisymmetry of the attenuator 33 and the cylinder portion 32 to increase the amplitude caused by vibrations generated by the piezoelectric element 9 further at the first external vibrator 3L than at the second external vibrator 3R. For example, the amplitude caused by vibrations of the external vibrator 3 has gradually decreasing variation from the first portions Q1 and R1 toward the second portions Q2 and R2 in a plan view in the first direction Z. Thus, the amplitude of the lens 5 connected to the first connector 31 can be varied. More specifically, the amplitude in an area of the surface of the lens 5, positioned closer to the first external vibrator 3L can be greater than the amplitude in an area of the surface of the lens 5, positioned closer to the second external vibrator 3R.

### Arrangement of Vibrating Device

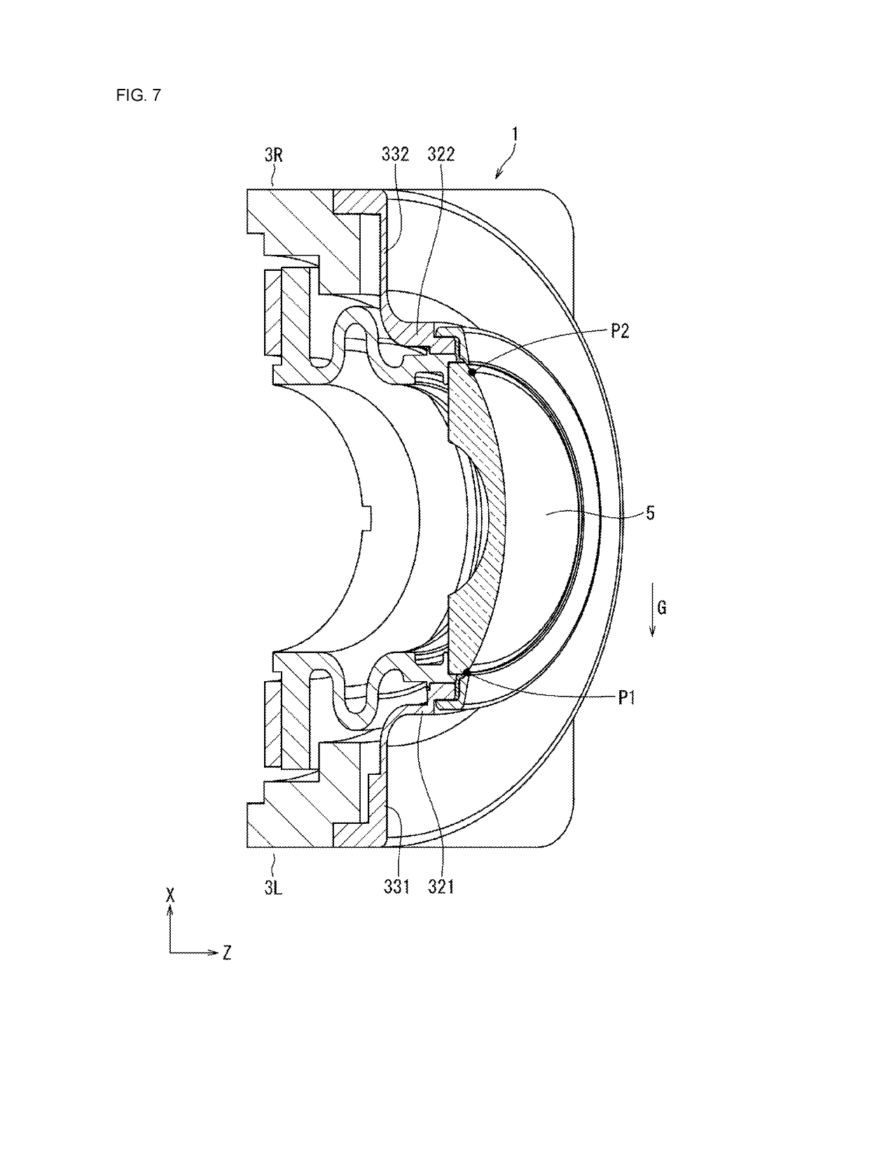

FIG. 7 is a schematic cross-sectional perspective view of an arrangement example of the vibrating device 1. The vibrating device 1 is disposed, for example, to have the second external vibrator 3R that causes relatively smaller amplitude positioned above, in the vertical direction, the first external vibrator 3L that causes relatively greater amplitude. With this arrangement, on the surface of the lens 5, the amplitude at a first point P1 positioned lower in the vertical direction is greater than the amplitude at a second point P2 positioned higher in the vertical direction.

For example, the first point P1 is positioned around a portion of an exposed surface of the lens 5 where the attenuator 33 is thickest and the cylinder portion 32 is thinnest (adjacent to the first portions Q1 and R1). For example, the second point P2 is positioned around a portion of an exposed surface of the lens 5 where the attenuator 33 is thinnest and the cylinder portion 32 is thickest (adjacent to the second portions Q2 and R2). The "exposed surface of the lens 5" is a portion of the upper surface of the lens 5 exposed from the external vibrator 3, the internal vibrator 7, and the cover member 8.

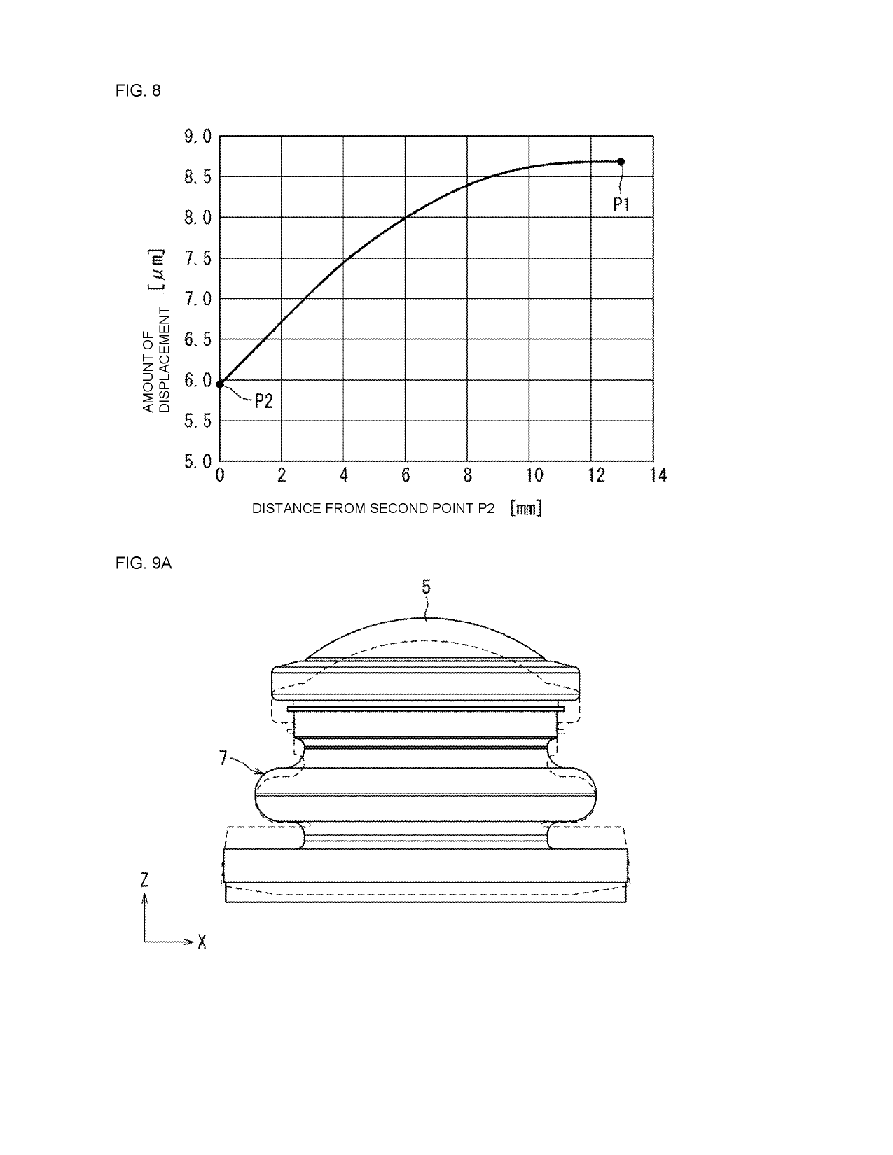

FIG. 8 is a graph of the amount of displacement on the exposed surface of the lens 5 along a line connecting the first point P1 and the second point P2. As is clear from FIG. 8, the amount of displacement (more specifically, the amplitude of the lens 5) gradually increases from the second point P2 toward the first point P1. When the vibrating device 1 is disposed to allow the amplitude on the surface of the lens 5 to gradually increase in a gravitational direction G (downward in the vertical direction), foreign matter on the surface of the lens 5 is more likely to slide down.

In the present embodiment, as illustrated in FIG. 2, a wire 100 is connected to the piezoelectric element 9 at a position closer to the second external vibrator 3R than to the first external vibrator 3L, and a voltage is applied to the piezoelectric element 9 through the wire 100. Connecting the wire 100 in this manner from a portion closer to the second external vibrator 3R that causes smaller amplitude can reduce disconnection of the wire 100 and noise caused by vibrations of the wire 100.

### Frequency Adjustment of Natural Vibration of External Vibrator 3

The dimensions of the attenuator 33 and the cylinder portion 32 can be adjusted to impart an intended variation to the amplitude of the lens 5.

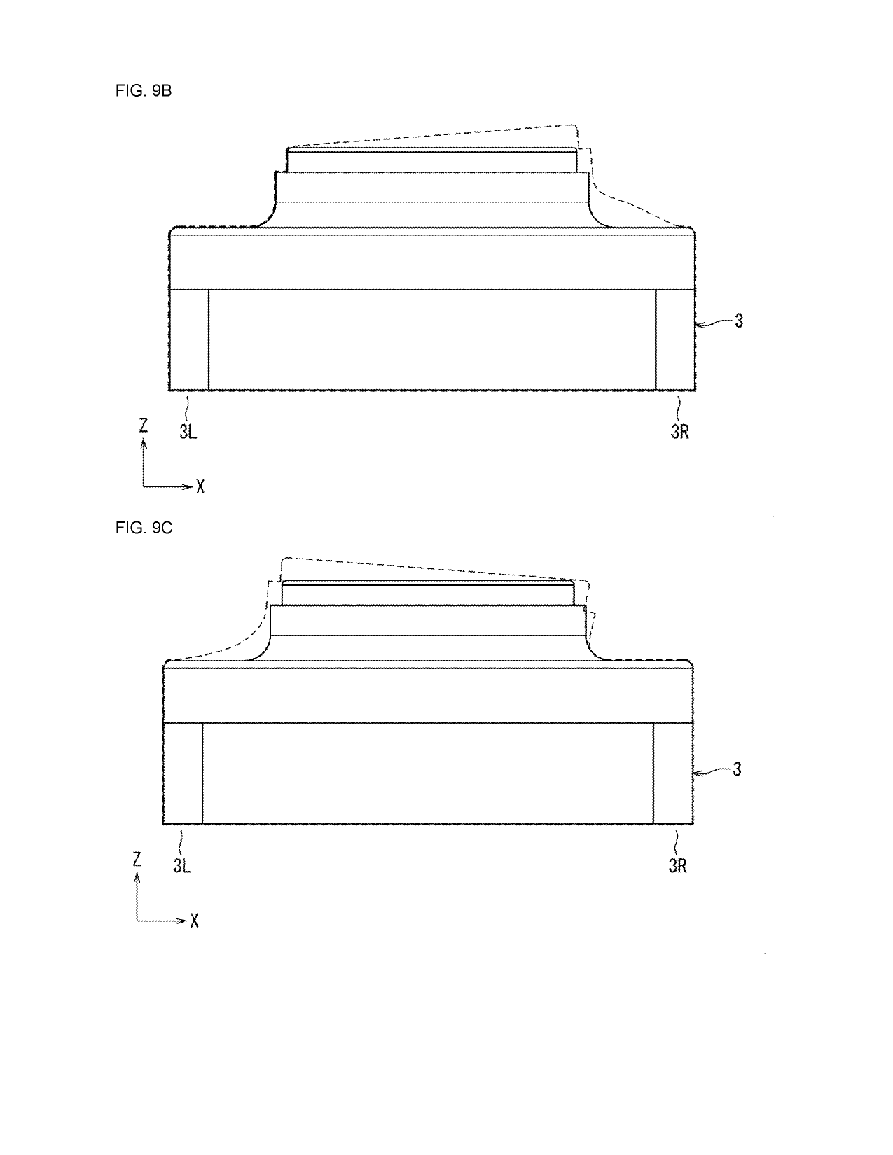

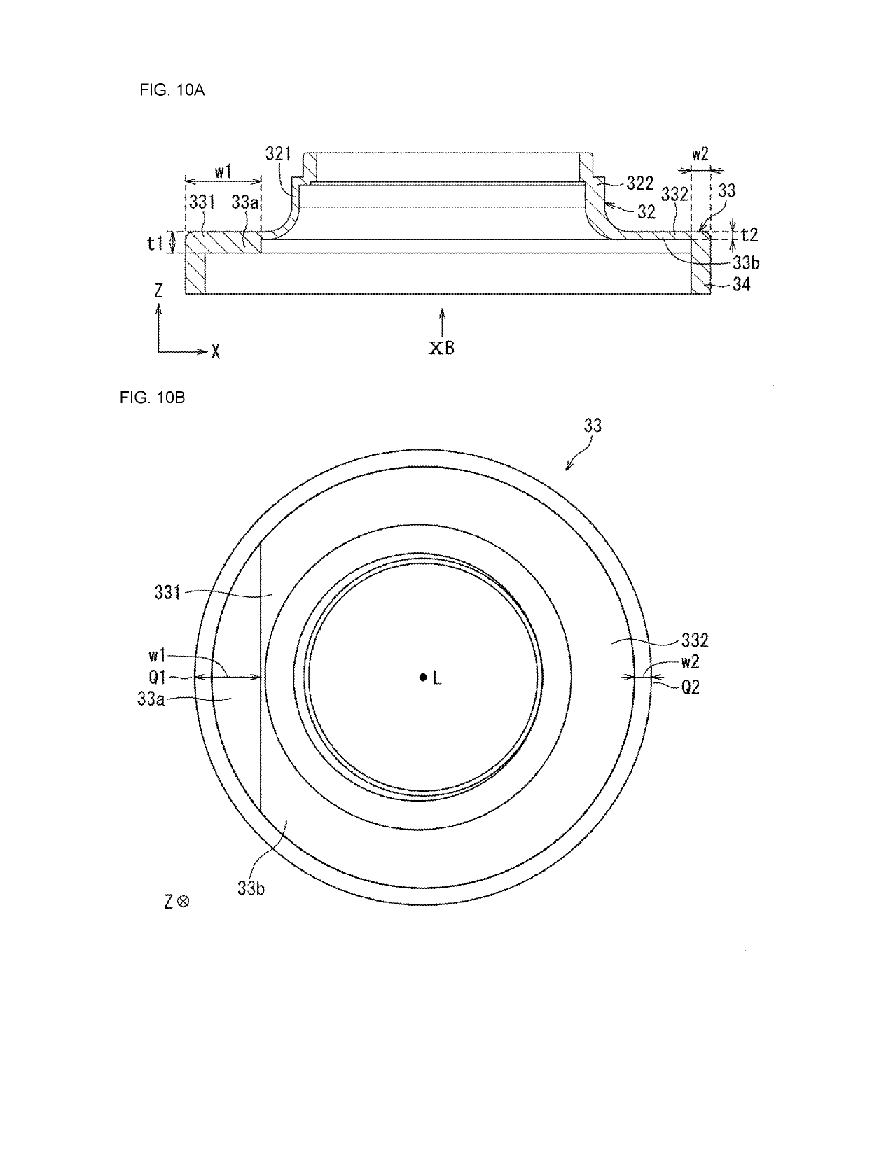

FIG. 9A is a schematic cross-sectional view of an example of natural vibration of an internal vibrator alone. FIG. 9B and FIG. 9C are schematic cross-sectional views of an example of natural vibration of an external vibrator alone. In these drawings, a stationary state is drawn with solid lines, and a vibrating state (where the amplitude is maximum) is drawn with dotted lines.

As illustrated in FIG. 9A, when not connected to an external vibrator, the internal vibrator 7 and the lens 5 vibrate in the first direction Z with contraction and expansion of the lower portion 72 with a letter S shape. The resonant frequency is, for example, 22 to 29 kHz.

The natural vibration of the external vibrator 3 alone can take, for example, two modes A and B illustrated in FIG. 9B and FIG. 9C. As illustrated in FIG. 9B, in the mode A, the amplitude of the first external vibrator 3L including a first attenuator and a first cylinder portion is smaller than the amplitude of the second external vibrator 3R including the second attenuator and the second cylinder portion. As illustrated in FIG. 9C, in the mode B, the amplitude of the first external vibrator 3L is greater than the second external vibrator 3R. Adjusting the frequencies (resonant frequencies) of natural vibration of these modes A and B allows natural vibration (FIG. 9A) on the internal vibrator 7 to be connected with amplitudes on either one of the modes. An intended variation can thus be imparted in the amplitude of the lens 5 without increasing a resonant resistance value of the internal vibrator 7.

Frequencies of the natural vibration of the external vibrator 3 in the modes A and B are adjustable by changing, for example, spring characteristics of the attenuator 33 and the cylinder portion 32. Spring characteristics of the attenuator 33 and the cylinder portion 32 are adjustable by changing, for example, materials or the following parameters illustrated in FIG. 6A.

t1, t2: thicknesses of the first and second attenuators 331 and 332 in the first direction Z

w1: width of the thick portion 33a in the attenuator 33

s1, s2: thicknesses of the first and second cylinder portions 321 and 322 in the second direction X

h: height of the cylinder portion 32 in the Z direction

u: distance in the second direction X between the outer surface of the cylinder portion 32 and the outer surface of the attenuator 33

In the present embodiment, frequency in the mode B is adjusted to be closer to the resonant frequency (for example, approximately 26 kHz) of simply the internal vibrator 7 than the frequency in the mode A is. For example, the frequency in the mode A may be adjusted to 19.1 kHz, and the frequency in the mode B may be adjusted to 29.6 kHz. Thus, the natural vibration (FIG. 9C) of the external vibrator 3 in the mode B and the natural vibration of the internal vibrator 7 can be coupled in the vibrating device 1. In this case, the amplitude of the first external vibrator 3L including a thick attenuator and a thin cylinder portion is greater than the amplitude of the second external vibrator 3R including a thin attenuator and a thick cylinder portion. Thus, the amplitude in an area of the lens 5 positioned closer to the first external vibrator 3L can be greater than the amplitude in an area of the lens 5 positioned closer to the second external vibrator 3R.

### Effects

The vibrating device 1 can exert effects described below.

The vibrating device 1 includes the substantially tubular internal vibrator 7 extending in the first direction, the piezoelectric element 9 connected to a first end portion of the internal vibrator 7 in the first direction Z, the light-transparent body (here, the lens 5) connected to a second end portion of the internal vibrator 7 in the first direction Z and having an optical axis L extending in the first direction Z, and the substantially tubular external vibrator 3 extending in the first direction Z. The external vibrator 3 is disposed to surround the internal vibrator 7. The external vibrator 3 includes the first connector 31 connected to the light-transparent body, the attenuator 33 extending toward the outside of the light-transparent body from the first connector 31 in the second direction X intersecting with the first direction Z, and the cylinder portion 32 connecting the first connector 31 and the attenuator 33 and extending in the first direction Z. The cylinder portion 32 is disposed at a distance from the internal vibrator 7 in the second direction X. At least one of the attenuator 33 or the cylinder portion 32 includes nonaxisymmetry with respect to the optical axis.

In the above structure, at least one of the attenuator 33 or the cylinder portion 32 in the external vibrator 3 includes nonaxisymmetry, and the amplitude on the surface of the light-transparent body can be varied under vibration. Thus, foreign matter adhering to the surface of the light-transparent body can be effectively removed. In addition, reducing imbalance of stress imposed on the internal vibrator 7 under vibration can reduce deterioration of impedance.

Herein, "being substantially tubular" indicates any structure having a through-hole extending in an extension direction (here, the first direction Z), including, for example, a substantially cylindrical shape and a substantially angular tube shape. The through-hole in a substantially tubular body has, for example, a substantially circular shape, for example, a perfect circle shape or an ellipse shape. The profile of the substantially tubular body may have a cylinder shape, or a substantially polygonal prism shape such as a quadrangular prism shape. The substantially tubular body may include a cone portion having a cross section that expands or contracts in the first direction Z, or a stepped portion. At least portions of the internal vibrator 7 and the external vibrator 3 positioned closer to the lens 5 preferably have a substantially cylindrical shape. This structure can impart an intended variation in the amplitude of the surface of the lens 5 while reducing disused vibrations.

In a cross section taken along the optical axis L, the attenuator 33 includes the first attenuator 331 and the second attenuator 332 positioned symmetrically with respect to the optical axis L, and the thickness t1 of the first attenuator 331 in the first direction Z and the thickness t2 of the second attenuator 332 in the first direction Z are different. In this structure, the vibrating device 1 has symmetric appearance while imparting nonaxisymmetry to the attenuator 33.

In the cross section taken along the optical axis L, the cylinder portion 32 includes the first cylinder portion 321 and the second cylinder portion 322 positioned symmetrically with respect to the optical axis L, and the thickness s1 of the first cylinder portion 321 in the second direction X and the thickness s2 of the second cylinder portion 322 in the second direction X are different. In this structure, the vibrating device 1 has symmetric appearance while imparting nonaxisymmetry to the cylinder portion 32.

Both the attenuator 33 and the cylinder portion 32 have nonaxisymmetry with respect to the optical axis. The attenuator 33 is mainly involved in vibrations in the first direction Z, and the cylinder portion 32 is mainly involved in vibrations in the second direction X. Thus, when both the attenuator 33 and the cylinder portion 32 have nonaxisymmetry, an intended variation is more likely to be imparted in the amplitude of the lens 5 by setting, for example, the dimensions, the direction, or the position of nonaxisymmetry of the attenuator 33 and the cylinder portion 32.

In the cross section taken along the optical axis L, the first attenuator 331 and the first cylinder portion 321 are positioned on a first side of the optical axis L, and the second attenuator 332 and the second cylinder portion 322 are positioned on a second side of the optical axis L. The thickness t1 of the first attenuator 331 in the first direction Z is greater than the thickness t2 of the second attenuator 332 in the first direction Z. The thickness s1 of the first cylinder portion 321 in the second direction X is smaller than the thickness s2 of the second cylinder portion 322 in the second direction X. Thus, the structure where the direction of nonaxisymmetry (here, the relationship in thickness) of the cylinder portion 32 is opposite to the direction of nonaxisymmetry of the attenuator 33 has the following effects.

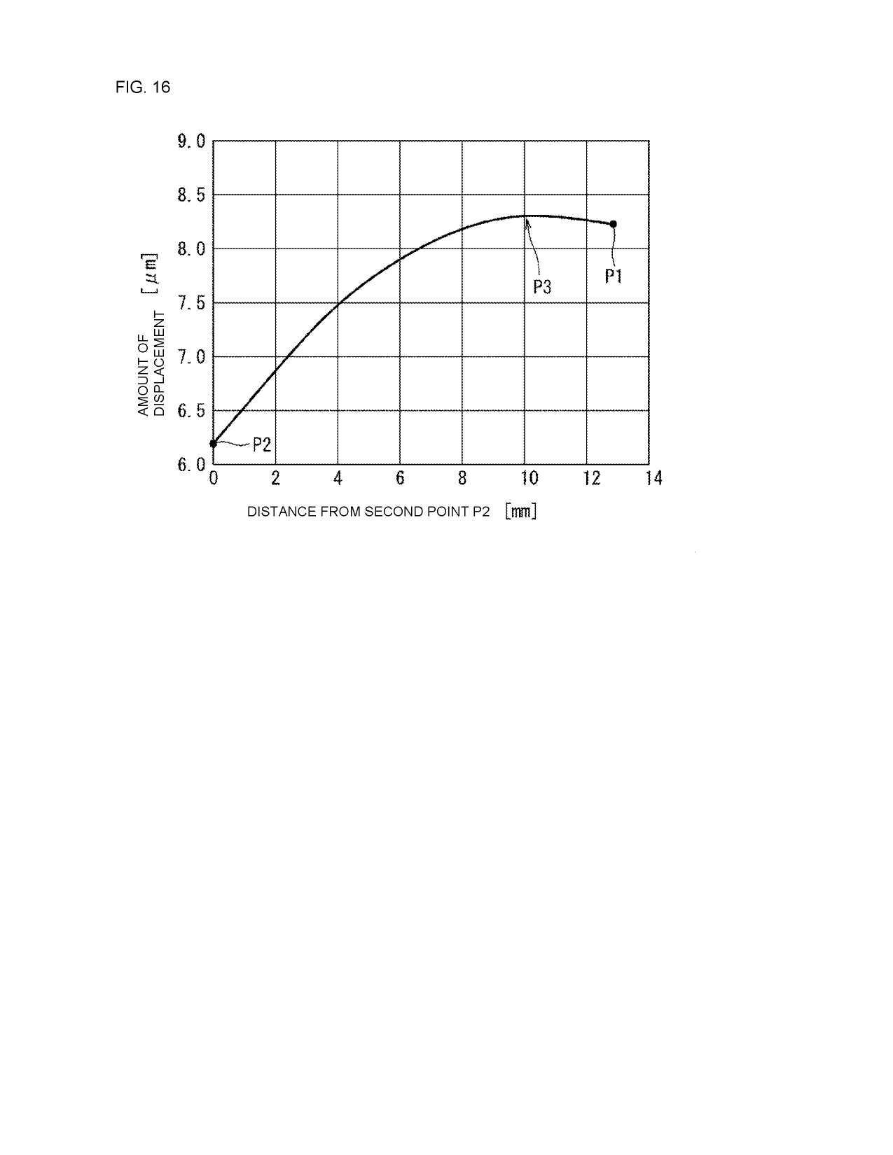

The present inventors have found, through study, nonaxisymmetry of the attenuator 33 alone is less likely to impart intended variation in the amplitude of the lens 5. When the thickness t1 of the first attenuator 331 is too small, the amplitude under vibration of the lens 5 may fail to be increased to the maximum at the end portion closer to the first attenuator 331. More specifically, the position of the maximum displacement point of the lens 5 is displaced from the end portion of the lens 5 toward the optical axis L (refer to FIG. 16). In contrast, when the thickness t1 of the first attenuator 331 is too large, vibrations transmitted to the fixed portion 35 positioned below (on the side away from the lens 5) increase, and vibration efficiency deteriorates during assembly of a camera module. In contrast, when the cylinder portion 32 has nonaxisymmetry in the opposite direction to the attenuator 33, the amount of displacement at an end portion of the lens 5 positioned closer to the first attenuator 331 can be further increased (for example, to the maximum) (refer to FIG. 8). This structure can thus impart an intended variation in the amplitude of the lens 5 while reducing degradation of vibration efficiency.

In the cross section taken along the optical axis L, the external vibrator 3 includes the first external vibrator 3L and the second external vibrator 3R positioned symmetrically with respect to the optical axis L. When the amplitude of the first external vibrator 3L caused by vibrations generated by the piezoelectric element 9 is greater than the amplitude of the second external vibrator 3R caused by vibrations generated by the piezoelectric element 9, the second external vibrator 3R is positioned higher than the first external vibrator 3L in the vertical direction. In this structure, the amplitude on the surface of the lens 5 is greater in an area positioned below in the vertical direction than in an area positioned above in the vertical direction. This structure can thus allow foreign matter adhering to the surface of the light-transparent body to slide down with vibrations. The structure where the amplitude on the surface of the lens 5 has variation gradually increasing in the gravitational direction G is more likely to facilitate sliding down of foreign matter.

When the amplitude of the first external vibrator 3L caused by vibrations generated by the piezoelectric element 9 is greater than the amplitude of the second external vibrator 3R caused by vibrations generated by the piezoelectric element 9, the wire 100 is connected to the piezoelectric element 9 at a position closer to the second external vibrator 3R than to the first external vibrator 3L. This structure can reduce disconnection of the wire 100 and noise caused by vibrations of the wire 100.

The internal vibrator 7 has axial symmetry with respect to the optical axis. In this structure, the internal vibrator 7 does not have nonaxisymmetric structure, and disused vibrations attributable to the structure of the internal vibrator 7 are less likely to occur. Thus, superimposition of disused vibrations of the internal vibrator 7 can be further reduced. This structure can thus further reduce deterioration of impedance. In addition, reducing imbalance of stress imposed on the internal vibrator 7 under vibration to the minimum can further reduce deterioration of impedance.

The piezoelectric element 9 has axial symmetry with respect to the optical axis L. In this structure, disused vibrations attributable to the structure of the piezoelectric element 9 are less likely to occur. Thus, superimposition of disused vibrations of the internal vibrator 7 can be reduced. This structure can thus further reduce deterioration of impedance.

The vibrating device 1 may have a structure described below.

In the example illustrated in FIG. 6B, the thick portion 33a in the attenuator 33 extends in the circumferential direction throughout the first attenuator 331, but as illustrated in FIG. 10A and FIG. 10B, the thick portion 33a may be positioned at a part of the first attenuator 331. In this example, the thick portion 33a includes a bow-shaped portion along a part of the outer edge of the first attenuator 331 when viewed in a plan in the -Z direction.

The dimensions (FIG. 4) of the attenuator 33 and the cylinder portion 32 may be adjusted to couple natural vibration of the external vibrator 3 in the mode A (FIG. 9B) and natural vibration of the internal vibrator 7. In this case, the amplitude of the first external vibrator 3L is smaller than the amplitude of the second external vibrator 3R. This structure can be achieved by, for example, reducing the height h of the cylinder portion 32.

Nonaxisymmetry of the attenuator 33 and/or the cylinder portion 32 is not limited to difference in thickness. Only one of the attenuator 33 or the cylinder portion 32 may have nonaxisymmetry.

### Modification Examples

Hereafter, vibrating devices according to modification examples are described. As in the case of the vibrating device 1 in FIG. 2, vibrating devices according to first to third modification examples described below can impart a variation in the amplitude of a lens without losing axial symmetry of an internal vibrator.

### First Modification Example

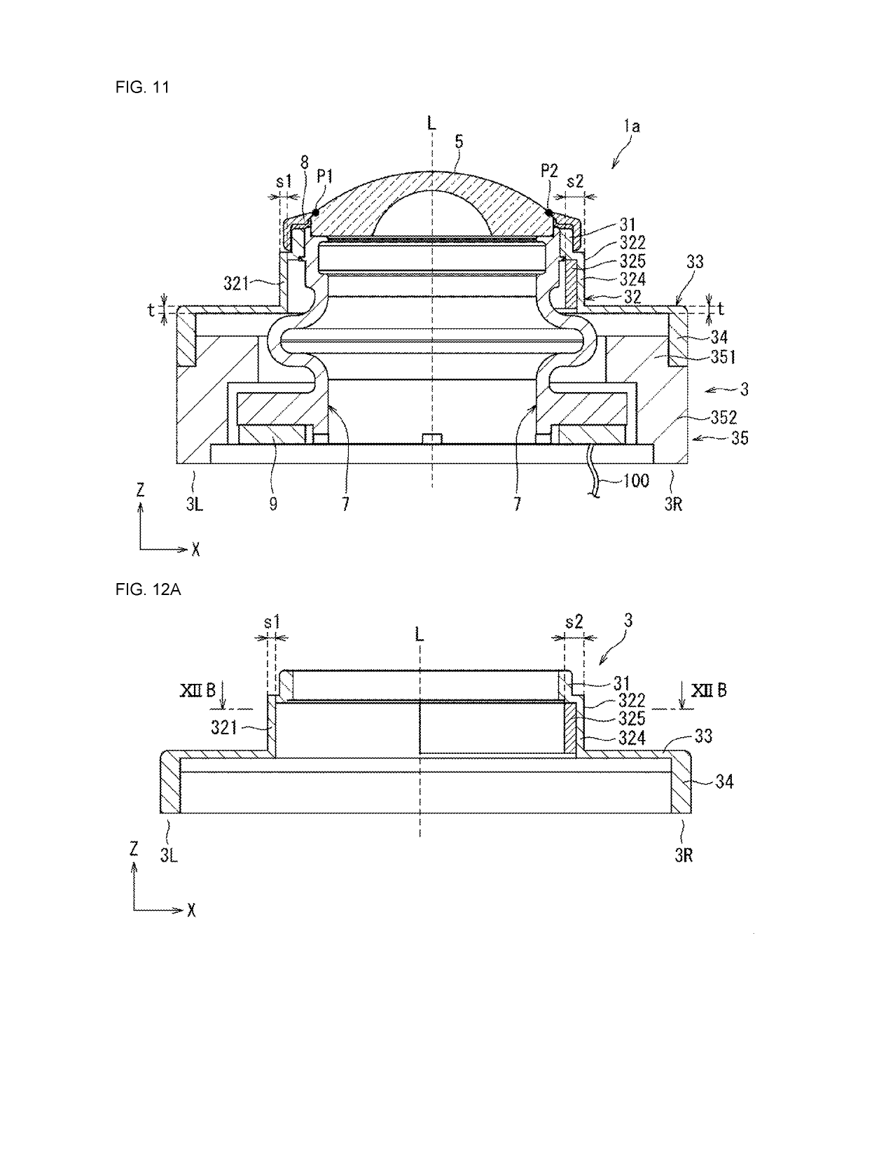

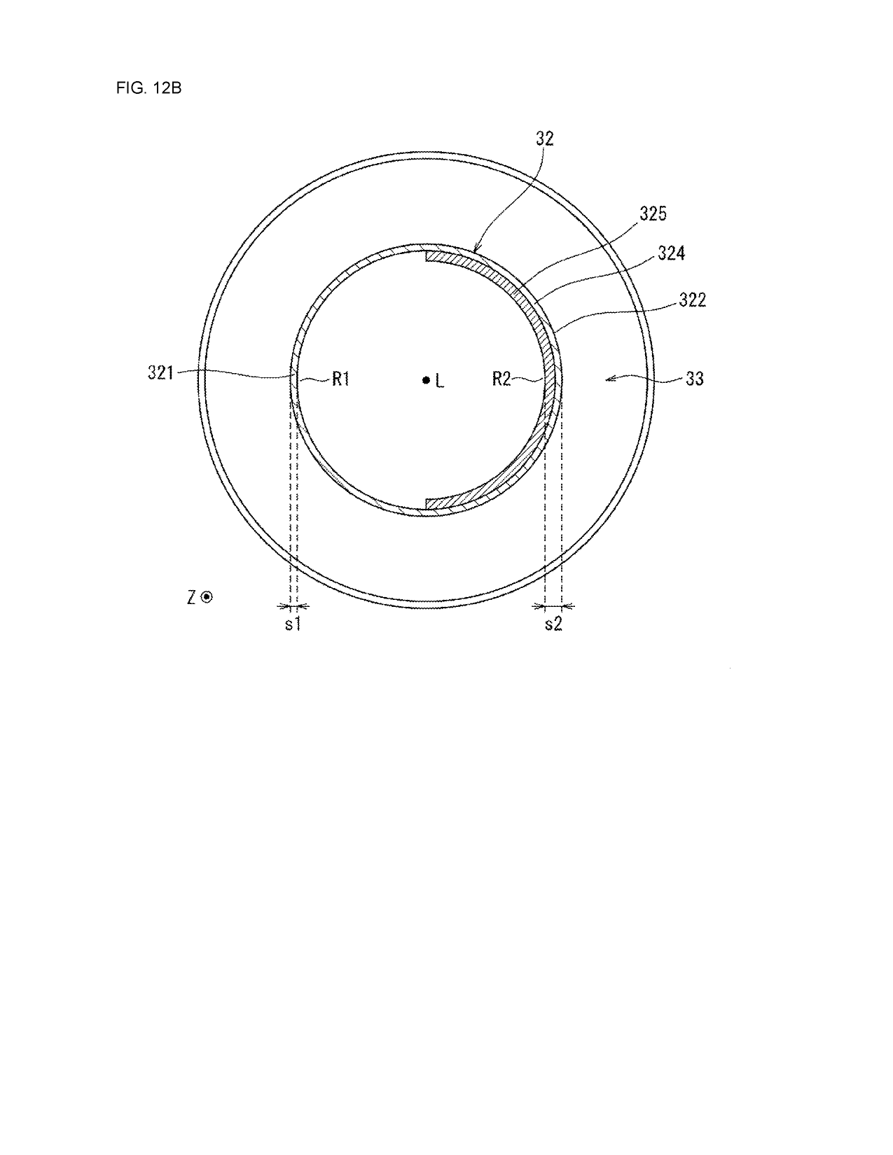

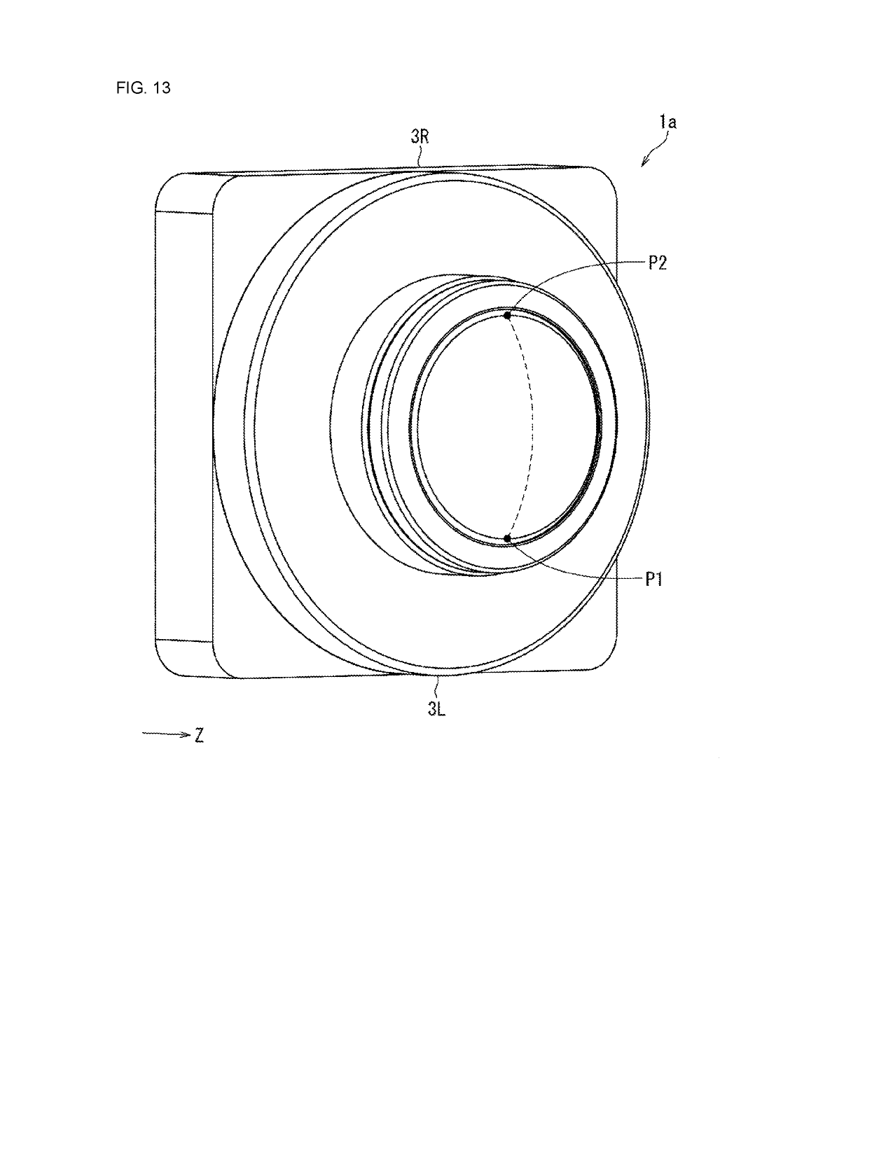

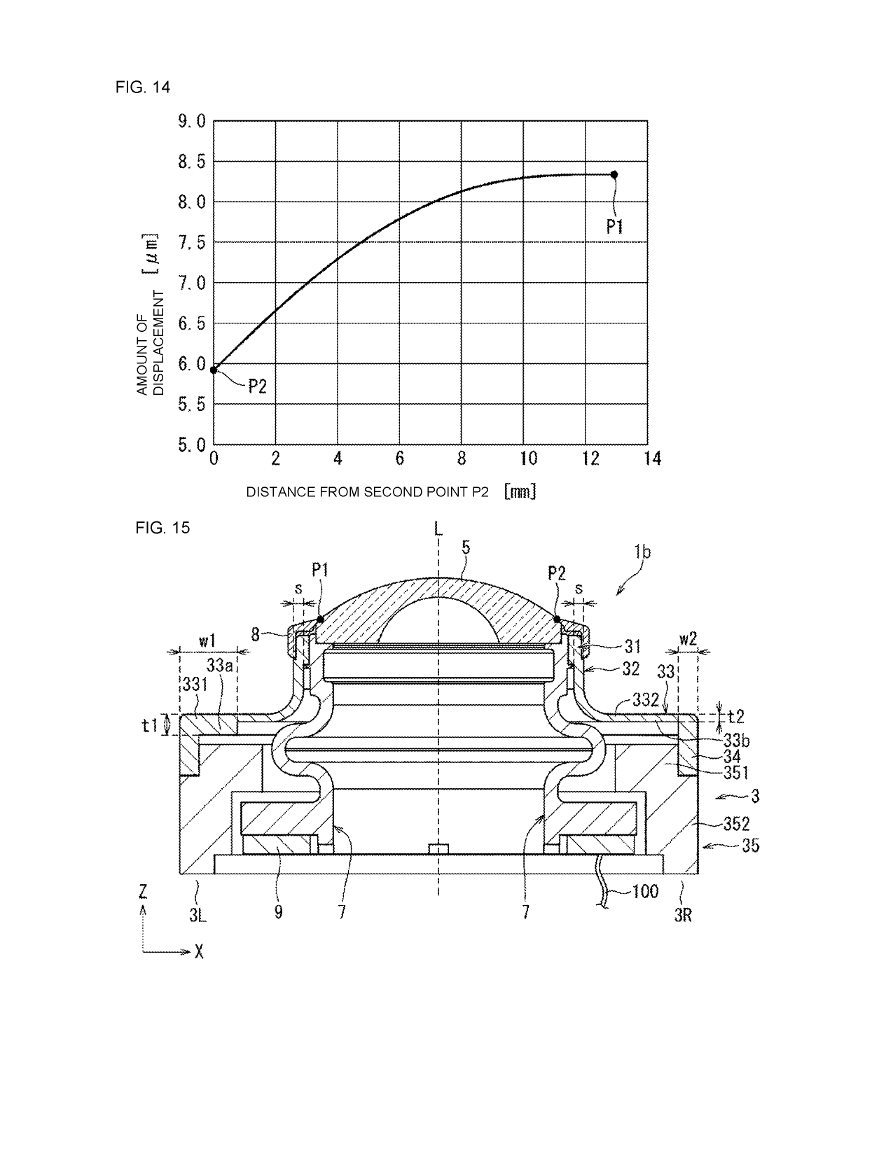

FIG. 11 is a schematic cross-sectional view of a vibrating device according to a first modification example. FIG. 12A is a schematic cross-sectional view of an external vibrator in the vibrating device in FIG. 11, excluding a fixed portion. FIG. 12B is a cross-sectional view taken along line XIIB-XIIB in FIG. 12A. FIG. 13 is a schematic perspective view of an arrangement example of the vibrating device in FIG. 11. FIG. 14 is a graph of an example of the amount of displacement of the surface of the lens 5 of the vibrating device in FIG. 11.

In a vibrating device 1a, the cylinder portion 32 has nonaxisymmetry with respect to the optical axis L. More specifically, the thickness s2 of the second cylinder portion 322 is greater than the thickness s1 of the first cylinder portion 321. In contrast, the attenuator 33 is axially symmetric with respect to the optical axis L. The thickness t of the attenuator 33 is, for example, substantially uniform throughout the circumference.

As illustrated in FIG. 12A and FIG. 12B, in the present modification example, the cylinder portion 32 includes a main portion 324 integrated with the attenuator 33, and a weight member 325. The main portion 324 has, for example, a substantially uniform thickness s1 throughout the circumference. The weight member 325 is positioned inside the main portion 324 in the second cylinder portion 322, and in contact with the inner surface of the main portion 324. The weight member 325 has, for example, a semi-cylindrical shape extending in the first direction Z. The thickness s2 of the second cylinder portion 322 in the second direction X corresponds to the total thickness of the main portion 324 and the weight member 325. Thus, the thickness s2 of the second cylinder portion 322 is greater than the thickness s1 of the first cylinder portion 321 by the thickness of the weight member 325.

The material of the weight member 325 may be the same as or different from the material of the attenuator 33. The modulus of elasticity of the material of the weight member 325 may be greater than the modulus of elasticity of the material of the attenuator 33. This structure can thus more efficiently impart a variation in the amplitude of the lens 5.

In the illustrated example, the weight member 325 is disposed throughout the height of the main portion 324 in the first direction Z. As illustrated in FIG. 12A, the weight member 325 and the main portion 324 extend to the upper surface of the attenuator 33 in the first direction Z. Thus, the cylinder portion 32 does not include an oblique portion illustrated in FIG. 2. The height of the weight member 325 in the first direction Z may be smaller than the height of the main portion 324.

In the vibrating device 1a according to the present modification example, for example, the amplitude of the second external vibrator 3R including the second cylinder portion 322 is smaller than the amplitude of the first external vibrator 3L including the first cylinder portion 321. In this case, as illustrated in FIG. 13, the vibrating device 1a is disposed to allow the second external vibrator 3R to be positioned higher in the vertical direction. For example, as illustrated in FIG. 14, this structure can gradually increase the amplitude under vibration from the second point P2 positioned at the upper end portion of the lens 5 toward the first point P1 positioned at the lower end portion of the lens 5. The first point P1 may be, for example, a point on the exposed surface of the lens 5 adjacent to the center point of the weight member 325 in the circumferential direction.

In the present modification example, the first cylinder portion 321 is formed from a part of the main portion (also referred to as "a first member") 324, and the second cylinder portion 322 is formed from another part of the main portion 324 and the weight member (also referred to as "a second member") 325. The weight member 325 is positioned on the inner side of the main portion 324. The weight member 325 may be formed from the same material as or a different material from the main portion 324. This structure allows the vibrating device 1 to have symmetric appearance while imparting nonaxisymmetry to the cylinder portion 32. This structure also allows the attenuator 33 (the first attenuator 331) to be thinner than the vibrating device 1 in FIG. 2. This structure can thus attenuate vibrations transmitted from the attenuator 33 to the fixed portion 35. The thickness of the cylinder portion may be partially varied without providing another member such as the weight member 325 (refer to FIG. 2).

### Second Modification Example

FIG. 15 is a schematic cross-sectional view of a vibrating device according to a second modification example. FIG. 16 is a schematic graph of an example of the amount of displacement of the lens surface of the vibrating device in FIG. 15.

In a vibrating device 1b, the attenuator 33 has nonaxisymmetry with respect to the optical axis L. For example, as in the case of the vibrating device 1 illustrated in FIG. 2, the thickness t1 of the first attenuator 331 is greater than the thickness t2 of the second attenuator 332. For example, as in the case of the structure illustrated in FIG. 6B or FIG. 13B, the attenuator 33 includes the thick portion 33a and the thin portion 33b. The cylinder portion 32 is axially symmetric with respect to the optical axis L. A thickness s of the cylinder portion 32 is, for example, substantially uniform throughout the circumference. This structure allows the vibrating device 1 to have symmetric appearance while imparting nonaxisymmetry to the attenuator 33.

In the vibrating device 1b according to the present modification example, the amplitude of the first external vibrator 3L including the first attenuator 331 is greater than the amplitude of the second external vibrator 3R including the second attenuator 332. In this case, the vibrating device 1b is disposed, for example, to allow the first portion Q1 in the first attenuator 331 (FIG. 6B) to be positioned below in the vertical direction, and to allow the second portion Q2 (FIG. 6B) in the second attenuator 332 to be positioned higher in the vertical direction. This structure thus allows, for example, the amplitude at the first point P1 at the lower end portion of the lens 5 to be greater than the amplitude at the second point P2 at the upper end portion of the lens 5, as illustrated in FIG. 16.

In the example illustrated in FIG. 16, on the exposed surface of the lens 5, a maximum displacement point P3 at which the amount of displacement is maximum is positioned closer to the second point P2 than the first point P1 is. When the first attenuator 331 is further thickened, the maximum displacement point P3 can be closer to the first point P1. However, when the attenuator 33 is thickened, vibrations transmitted from the attenuator 33 to the fixed portion 35 below the attenuator 33 are more likely to be increased, and vibration efficiency may be reduced. Thus, in the present modification example, the thickness t1 of the first attenuator 331 is adjusted to facilitate sliding down of foreign matter by bringing the maximum displacement point P3 closer to the first point P1 (lower end portion of the lens 5) as much as possible while retaining vibration efficiency.

In the vibrating device 1b, the amplitude of the first attenuator 331 may be smaller than the amplitude of the second attenuator 332. Such a structure can be achieved by, for example, adjusting dimensions such as reduction of the height h of the cylinder portion 32.

### Third Modification Example

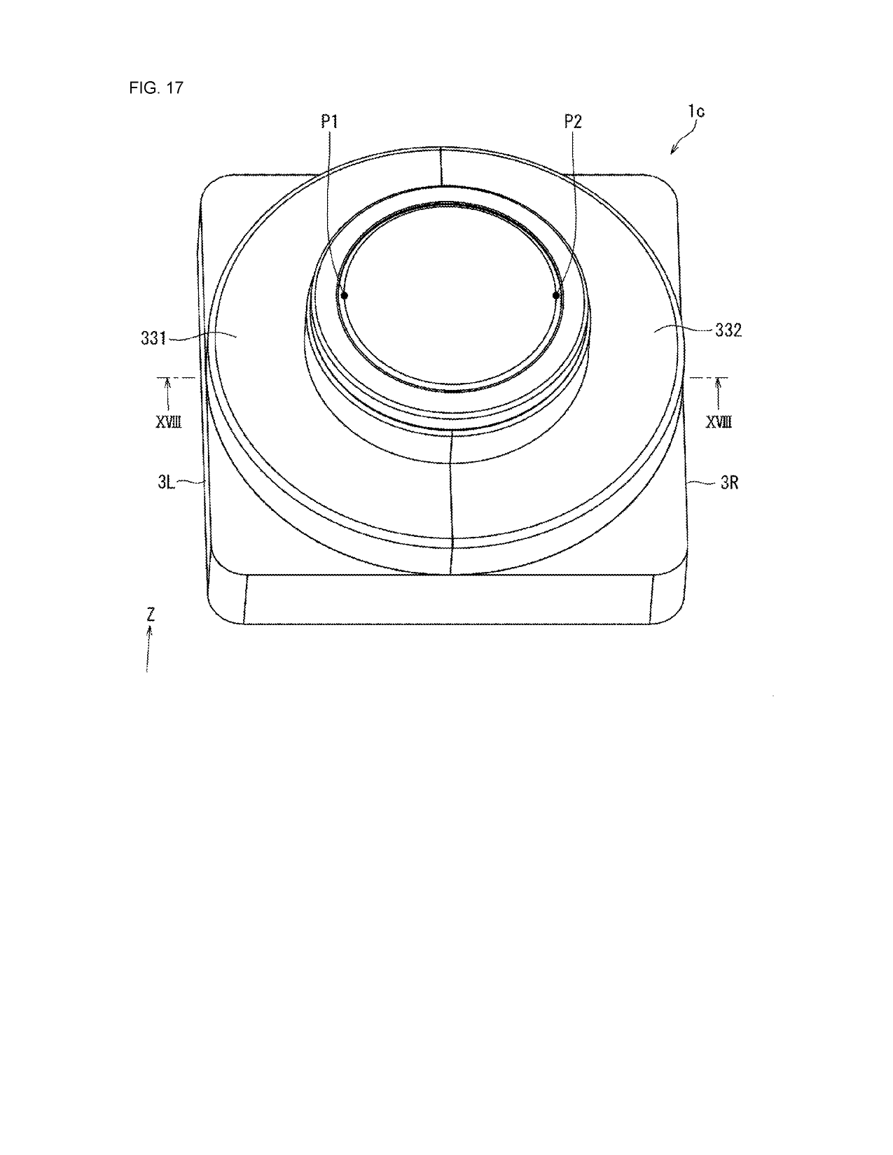

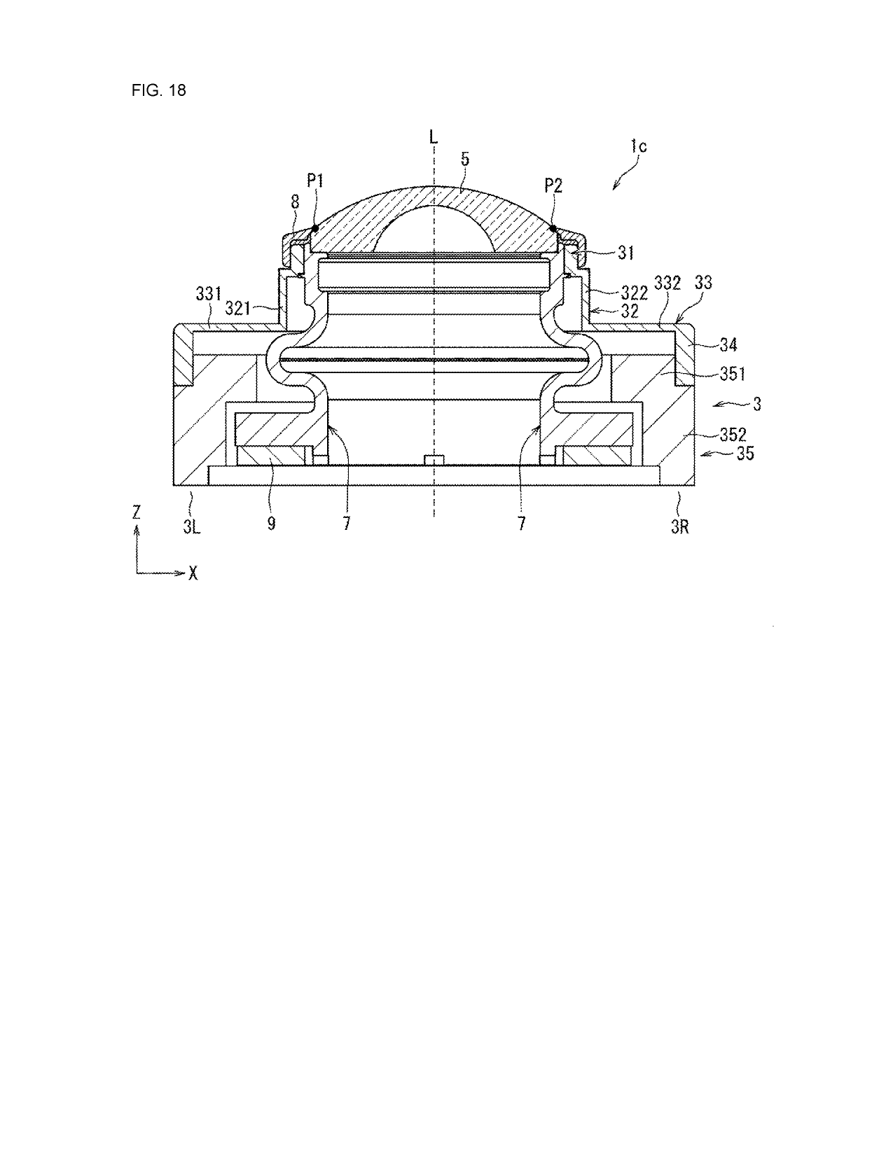

FIG. 17 is a schematic perspective view of a vibrating device according to a third modification example. FIG. 18 is a schematic cross-sectional view taken along line XVIII-XVIII in FIG. 17.

In a vibrating device 1c, the material of the first attenuator 331 and the first cylinder portion 321 differs from the material of the second attenuator 332 and the second cylinder portion 322. The attenuator 33 and the cylinder portion 32 may both be axially symmetric with respect to the optical axis L. This structure allows the vibrating device 1 to have symmetric appearance while imparting nonaxisymmetry to the attenuator 33 and the cylinder portion 32.

In the example illustrated in FIG. 17 and FIG. 18, a portion of the external vibrator 3 excluding the fixed portion 35 is formed from two materials. More specifically, the first connector 31, the cylinder portion 32 (the first cylinder portion 321), the attenuator 33 (the first attenuator 331), and the second connector 34 included in the first external vibrator 3L are formed from a first material. The first connector 31, the cylinder portion 32 (the second cylinder portion 322), the attenuator 33 (the second attenuator 332), and the second connector 34 included in the second external vibrator 3R are formed from a second material different from the first material.

For example, materials with different moduli of elasticity (Young's moduli) may be selected as the first material and the second material. For example, when the modulus of elasticity of the second material is greater than the modulus of elasticity of the first material, the amplitude of the second external vibrator 3R formed from the second material is smaller than the amplitude of the first external vibrator 3L formed from the first material. In this case, the vibrating device 1c is disposed, for example, to allow the second external vibrator 3R to be positioned higher than the first external vibrator 3L in the vertical direction.

In the present modification example, both of the attenuator 33 and the cylinder portion 32 are formed from two materials, but only one of the attenuator 33 or the cylinder portion 32 may be formed from two materials. In the present modification example, the first material and the second material have different moduli of elasticity, but may be different in density or mechanical Q factor. The structure may have any unlimited characteristics, such as the material type used, the number of materials used, the arrangement of each material, or the rate of each material as long as the structure can impart nonaxisymmetry to at least one of the attenuator 33 or the cylinder portion 32.

A structure of a vibrating device according to the present disclosure is not limited to the structure described above with reference to FIG. 1 to FIG. 18. In these drawings, the attenuator 33 and the cylinder portion 32 are integrated, but may be formed from separate members.

Nonaxisymmetry of the attenuator 33 and the cylinder portion 32 may be imparted by combining any two or more of the components described above. For example, the attenuator 33 and/or the cylinder portion 32 may partially differ in both material and thickness.

By appropriately combining any of the various embodiments or modification examples described above, the effects thereof can be achieved. In addition, a combination of embodiments with each other, a combination of examples with each other, or a combination of embodiments with examples is possible, and features of different embodiments or examples may also be combined with each other.

Although the present disclosure describes the embodiments with a certain degree of detail, the disclosed embodiments may be varied in terms of structural details, and changes in the combination and order of elements in each embodiment may be made without departing from the scope and spirit of the disclosure.

A vibrating device according to the present disclosure can remove foreign matter adhering to a light-transparent body, and is thus applicable to, for example, an image pickup unit.

### Reference Signs List

1, 1a, 1b, 1c vibrating device

3 external vibrator

3L first external vibrator

3R second external vibrator

5 lens

7 internal vibrator

8 cover member

9 piezoelectric element

31 first connector

32 cylinder portion

33 attenuator

33a thick portion

33b thin portion

34 second connector

35 fixed portion

41 upper tubular body

42 lower tubular body

51 flat portion

52 recessed portion

53 upper surface

71 upper portion

72 lower portion

73 intermediate portion

100 wire

321 first cylinder portion

322 second cylinder portion

324 main portion

325 weight member

331 first attenuator

332 second attenuator

711 plate portion

712 protrusion

L optical axis

Q1, Q2 portion of attenuator

R1, R2 portion of cylinder portion

P1 first point

P2 second point

1. A vibrating device, comprising:
a substantially tubular internal vibrator extending in a first direction;
a piezoelectric element connected to a first end portion of the substantially tubular internal vibrator in the first direction;
a light-transparent body connected to a second end portion of the substantially tubular internal vibrator in the first direction and having an optical axis extending in the first direction; and
a substantially tubular external vibrator surrounding the substantially tubular internal vibrator and extending in the first direction,
wherein the substantially tubular external vibrator includes:
a first connector connected to the light-transparent body,
a cylinder portion connected to the first connector and extending in the first direction, and
an attenuator extending from the cylinder portion in a direction away from the light-transparent body in a second direction intersecting with the first direction,
wherein the cylinder portion is spaced from the substantially tubular internal vibrator in the second direction, and
wherein at least one of the attenuator or the cylinder portion has nonaxisymmetry with respect to the optical axis.

2. The vibrating device according to claim 1, wherein, in a cross section taken along the optical axis:
the attenuator includes a first attenuator and a second attenuator positioned symmetrically with respect to the optical axis, and
a thickness of the first attenuator in the first direction and a thickness of the second attenuator in the first direction are different from each other.

3. The vibrating device according to claim 1, wherein, in the cross section taken along the optical axis:
the cylinder portion includes a first cylinder portion and a second cylinder portion positioned symmetrically with respect to the optical axis, and
a thickness of the first cylinder portion in the second direction and a thickness of the second cylinder portion in the second direction are different from each other.

4. The vibrating device according to claim 3,
wherein the cylinder portion includes a first member and a second member,
wherein the first cylinder portion comprises a first portion of the first member,
wherein the second cylinder portion comprises a second portion of the first member and the second member, and
wherein in the second cylinder portion, the second member is between the second portion of the first member and the substantially tubular internal vibrator.

5. The vibrating device according to claim 1, wherein both of the attenuator and the cylinder portion have nonaxisymmetry with respect to the optical axis.

6. The vibrating device according to claim 5,
wherein, in a cross section taken along the optical axis:
the attenuator includes a first attenuator and a second attenuator positioned symmetrically with respect to the optical axis,
the cylinder portion includes a first cylinder portion and a second cylinder portion positioned symmetrically with respect to the optical axis,
the first attenuator and the first cylinder portion are positioned on a first side of the optical axis, and the second attenuator and the second cylinder portion are positioned on a second side of the optical axis,
a thickness of the first attenuator in the first direction is greater than a thickness of the second attenuator in the first direction, and
a thickness of the first cylinder portion in the second direction is smaller than a thickness of the second cylinder portion in the second direction.

7. The vibrating device according to claim 5, wherein, in a cross section taken along the optical axis:
the attenuator includes a first attenuator and a second attenuator positioned symmetrically with respect to the optical axis, and
a thickness of the first attenuator in the first direction and a thickness of the second attenuator in the first direction are different from each other.

8. The vibrating device according to claim 7, wherein, in the cross section taken along the optical axis:
the cylinder portion includes a first cylinder portion and a second cylinder portion positioned symmetrically with respect to the optical axis, and
a thickness of the first cylinder portion in the second direction and a thickness of the second cylinder portion in the second direction are different from each other.

9. The vibrating device according to claim 8,
wherein the cylinder portion includes a first member and a second member,
wherein the first cylinder portion comprises a first portion of the first member,
wherein the second cylinder portion comprises a second portion of the first member and the second member, and
wherein in the second cylinder portion, the second member is between the second portion of the first member and the substantially tubular internal vibrator.

10. The vibrating device according to claim 5, wherein, in the cross section taken along the optical axis:
the cylinder portion includes a first cylinder portion and a second cylinder portion positioned symmetrically with respect to the optical axis, and
a thickness of the first cylinder portion in the second direction and a thickness of the second cylinder portion in the second direction are different from each other.

11. The vibrating device according to claim 10,
wherein the cylinder portion includes a first member and a second member,
wherein the first cylinder portion comprises a first portion of the first member,
wherein the second cylinder portion comprises a second portion of the first member and the second member, and
wherein in the second cylinder portion, the second member is between the second portion of the first member and the substantially tubular internal vibrator.

12. The vibrating device according to claim 1,
wherein, in a cross section taken along the optical axis, the attenuator includes a first attenuator and a second attenuator positioned symmetrically with respect to the optical axis, and
wherein the first attenuator and the second attenuator comprise different materials.

13. The vibrating device according to claim 1,
wherein, in a cross section taken along the optical axis, the cylinder portion includes a first cylinder portion and a second cylinder portion positioned symmetrically with respect to the optical axis, and
wherein the first cylinder portion and the second cylinder portion comprise different materials.

14. The vibrating device according to claim 1,
wherein, in a cross section taken along the optical axis, the substantially tubular external vibrator includes a first external vibrator and a second external vibrator positioned symmetrically with respect to the optical axis, and
wherein, when a first amplitude of the first external vibrator caused by vibrations generated by the piezoelectric element is greater than a second amplitude of the second external vibrator caused by vibrations generated by the piezoelectric element, the second external vibrator is positioned higher than the first external vibrator in a vertical direction.

15. The vibrating device according to claim 1, wherein the substantially tubular internal vibrator has axial symmetry with respect to the optical axis.

16. The vibrating device according to claim 1, wherein the piezoelectric element has axial symmetry with respect to the optical axis.

17. The vibrating device according to claim 1,
wherein, in a cross section taken along the optical axis, the substantially tubular external vibrator includes a first external vibrator and a second external vibrator positioned symmetrically with respect to the optical axis, and
the vibrating device further comprises a wire connected to the piezoelectric element at a position closer to the second external vibrator than to the first external vibrator.
